(19) United States
(12) Patent Application Publication
(10) Pub. No.: US 2026/0140050 A1
(43) Pub. Date: May 21, 2026

(54) ANALYTE SENSOR WITH SPATIALLY DISTRIBUTED PHOTODETECTORS, SPATIALLY DISTRIBUTED LIGHT SOURCES, AND/OR CO-LOCATED LIGHT SOURCES

(71) Applicant: Senseonics, Incorporated, Germantown, MD (US)

(72) Inventors: James Masciotti, Germantown, MD (US); Lee Johnson, Germantown, MD (US); Yahya Hosseini, Germantown, MD (US)

(73) Assignee: Senseonics, Incorporated, Germantown, MD (US)

(21) Appl. No.: 19/373,160

(22) Filed: Oct. 29, 2025

Related U.S. Application Data
(60) Provisional application No. 63/721,175, filed on Nov. 15, 2024.

(51) Int. Cl. G01N 21/31

(52) U.S. Cl. CPC G01N 21/314; G01N 2021/3148; G01N 2021/3166

(57) ABSTRACT

A sensor may include a substrate and an array of photodetectors mounted on or fabricated in the substrate. The array may include first photodetectors configured to detect light in a first wavelength range and second photodetectors configured to detect light in a second wavelength range that is different from the first wavelength range. The first photodetectors may be spatially distributed the array of photodetectors, and the second photodetectors may be spatially distributed spatially distributed throughout the array of photodetectors. One or more light sources may be mounted on or fabricated in the substrate. The one or more lights sources may be interleaved with the photodetectors, or the first and second light emitting active areas of first and second light sources may be co-located.

### CROSS-REFERENCE TO RELATED APPLICATION

The present application claims the benefit of priority to U.S. Provisional Application No. 63/721,175, filed Nov. 15, 2024, which is incorporated herein by reference in its entirety.

### BACKGROUND

### Field of Invention

The present invention relates generally to analyte monitoring. More specifically, the present invention relates to an analyte monitoring system including an analyte sensor with multiple photodetectors and/or multiple light sources.

### Discussion of the Background

Conventional analyte sensors may include one or more photodetectors and one or more light sources. For example, a conventional analyte sensor may include a light source that emits excitation light that interacts with an analyte indicator. When irradiated by the excitation light, the analyte indicator may emit emission light. The amount of emission light may be indicative of an amount of analyte (e.g., glucose) in proximity to the analyte indicator (e.g., in interstitial fluid in proximity to the analyte indicator). The conventional analyte sensor may measure the emission light using one or more first photodetectors. The conventional analyte sensor may also use one or more second photodetectors to measure the excitation light that is reflected from the analyte indicator. The measurement of the reflected excitation light can be used as a reference (e.g., to calibrate the sensor, such as by calibrating the measurement of the emission light). Further, some analyte sensors are not limited to just one light source but can include other light sources (e.g., for measuring one or more different analyte levels, one or more interferents with the analyte indicator, and/or degradation of the analyte indicator).

### SUMMARY

In conventional sensors, the spacing of photodetectors (e.g., first and second photodetectors) relative to light sources may affect the amount of light to which each photodetector is exposed, and the photodetectors may receive light from only a portion of the indicator material. Disparate spacing of photodetectors relative to light sources may also make it more difficult to calibrate the sensor (e.g., because determining the ratio of measured emission light to reflected excitation light would have to account for the positioning of the photodetectors relative to one or more of the light sources) and may decrease the overall accuracy of the sensor. The present invention may overcome one or more disadvantages of conventional sensors by co-locating light emitting active areas of light sources, interleaving photodetectors, and/or interleaving light sources with the photodetectors, which may improve sensor accuracy.

One aspect of the invention may provide a sensor including a substrate and an array of photodetectors mounted on or fabricated in the substrate. The array of photodetectors may include first photodetectors configured to detect light in a first wavelength range and second photodetectors configured to detect light in a second wavelength range that is different from the first wavelength range. The first photodetectors may be spatially distributed throughout the array of photodetectors, and the second photodetectors may be spatially distributed throughout the array of photodetectors. Each photodetector of the array of photodetectors may include an anode and a cathode. The anodes of the first photodetectors may be connected together. The cathodes of the first photodetectors may be connected together. The anodes of the second photodetectors may be connected together. The cathodes of the second photodetectors may be connected together. The first photodetectors may generate a single first output signal from the array of photodetectors. The second photodetectors may generate a single second output signal from the array of photodetectors.

In some aspects, the first photodetectors may be interleaved with the second photodetectors.

In some aspects, the array of photodetectors may include rows and columns, and each of the rows of the sensor may include at least one of the first photodetectors and at least one of the second photodetectors. In some aspects, each of the columns of the sensor may include at least one of the first photodetectors and at least one of the second photodetectors. In some aspects, none of the first photodetectors of the array of photodetectors may be adjacent to another of the first photodetectors, and none of the second photodetectors of the array of photodetectors may be adjacent to another of the second photodetectors. In some aspects, at least one of the rows and/or at least one of the columns may include two or more of the first photodetectors.

In some aspects, the sensor may include analyte indicator molecules that may be excited by light within the second wavelength range and may emit light within the first wavelength range.

In some aspects, the array of photodetectors may further include third photodetectors configured to detect light in a third wavelength range that may be different from the first and second wavelength ranges, and the third photodetectors may be spatially distributed throughout the array of photodetectors. In some aspects, the anodes of the third photodetectors may be connected together, and the cathodes of the third photodetectors may be connected together. In some aspects, the third photodetectors may generate a single third output signal from the array of photodetectors. In some aspects, the first photodetectors may be interleaved with the second and third photodetectors.

In some aspects, the array of photodetectors may include rows and columns, each of the rows of the sensor may include at least one of the third photodetectors, and each of the columns may include at least one of the third photodetectors. In some aspects, none of the third photodetectors of the array of photodetectors may be adjacent to another of the third photodetectors. In some aspects, the sensor may include degradation indicator molecules that may emit light in the third wavelength range.

In some aspects, the array of photodetectors may be a first array of photodetectors, and the sensor may further include a second array of photodetectors mounted on or fabricated in the substrate. In some aspects, the second array of photodetectors may include first photodetectors configured to detect light in the first wavelength range and second photodetectors configured to detect light in the second wavelength range. In some aspects, the first photodetectors of the second array of photodetectors may be spatially distributed throughout the second array of photodetectors, and the second photodetectors of the second array of photodetectors may be spatially distributed throughout the second array of photodetectors. In some aspects, each photodetector of the second array of photodetectors may include an anode and a cathode, the anodes of the first photodetectors of the second array of photodetectors may be connected together, the cathodes of the first photodetectors of the second array of photodetectors may be connected together, and the anodes of the second photodetectors of the second array of photodetectors may be connected together. In some aspects, the first photodetectors of the second array of photodetectors may generate a single first output signal from the second array of photodetectors, and the second photodetectors of the second array of photodetectors may generate a single second output signal from the second array of photodetectors. In some aspects, the first photodetectors of the second array of photodetectors may be interleaved with the second photodetectors of the second array of photodetectors.

In some aspects, the second array of photodetectors may include rows and columns, each of the rows of the second array of photodetectors may include at least one of the first photodetectors of the second array of photodetectors and at least one of the second photodetectors of the second array of photodetectors. In some aspects, each of the columns of the second array may include at least one of the first photodetectors of the second array and at least one of the second photodetectors. In some aspects, none of the first photodetectors of the second array may be adjacent to another of the first photodetectors of the second array, and none of the second photodetectors of the second array may be adjacent to another of the second photodetectors of the second array. In some aspects, at least one of the rows of the second array and/or at least one of the columns of the second array includes two or more of the first photodetectors of the second array.

In some aspects, the sensor may further include a light source mounted on or fabricated in the substrate, and the light source may be configured to emit light in the second wavelength range. In some aspects, the light source may be interleaved with the photodetectors of the array of photodetectors. In some aspects, the array of photodetectors may be a first array of photodetectors, the sensor may further include a second array of photodetectors, and the light source may be between the first and second arrays.

In some aspects, the light source may be a first light source, and the sensor may further include a second light source mounted on or fabricated in the substrate. In some aspects, the second light source may be configured to emit light in the second wavelength range. In some aspects, the array of photodetectors may be a first array of photodetectors, and the sensor may further include a second array of photodetectors. In some aspects, the first and second light sources may be between the first and second arrays.

In some aspects, the sensor may include first and second light source mounted on or fabricated in the substrate. In some aspects, the first light source may be configured to emit light in the second wavelength range. In some aspects, the second light source may be configured to emit light in the first wavelength range. In some aspects, the first and second light sources may be interleaved with the photodetectors of the array of photodetectors and with each other. In some aspects, the array of photodetectors may be a first array of photodetectors, the sensor may further include a second array of photodetectors, and the first and second light sources may be between the first and second arrays.

In some aspects, the first light source may include a first light emitting active area, the second light source may include a second light emitting active area, the first light source may be adjacent to the second light source, and the first and second light sources may be oriented such that the first and second light emitting active areas are co-located.

In some aspects, the sensor may further include first optical filters configured to allow light in the first wavelength range to reach the first photodetectors and to prevent light outside the first wavelength range from reaching the first photodetectors. In some aspects, the sensor may further include second optical filters that may be configured to allow light in the second wavelength range to reach the second photodetectors and to prevent light outside the second wavelength range from reaching the second photodetectors.

Another aspect of the invention may provide a sensor including a first and second light sources and a substrate. The first light source may include a first light emitting active area. The second light source may include a second light emitting active area, and a substrate. The first light source may be mounted on or fabricated in the substrate. The second light source may be mounted on or fabricated in the substrate adjacent to the first light source. The first and second light sources may be oriented such that the first and second light emitting active areas may be co-located.

In some aspects, the first light emitting active area may be adjacent to the second light emitting active area.

In some aspects, the sensor may further include a third light source including a third light emitting active area. The third light source may be mounted on or fabricated in the substrate. The sensor may additionally include a fourth light source including a fourth light emitting active area. The fourth light source may be mounted on or fabricated in the substrate adjacent to the third light source, and the third and fourth light sources may be oriented such that the third and fourth light emitting active areas may be co-located.

In some aspects, the first light emitting active area may be configured to emit light in a first wavelength range, and the second light active emitting area may be configured to emit light in a second wavelength range that may be different from the first wavelength range. In some aspects, the light in the first wavelength range may include ultraviolent light, and the light in the second wavelength range may include blue light.

In some aspects, the sensor may further include a first array of photodetectors mounted on or fabricated in the substrate and a second array of photodetectors mounted on or fabricated in the substrate. In some aspects, the first and second light sources may be between the first and second arrays of photodetectors. In some aspects, the first and second arrays of photodetectors may each include one or more first photodetectors configured to detect light in a first wavelength range and one or more second photodetectors configured to detect light in a second wavelength range different from the first wavelength range. In some aspects, the first and second arrays of photodetectors each include one or more third photodetectors configured to detect light in a third wavelength range that is different from the first and second wavelength ranges.

Still another aspect of the invention may provide a sensor including a substrate and a column of photodetectors mounted on or fabricated in the substrate. The column of photodetectors may include first photodetectors configured to detect light in a first wavelength range and second photodetectors configured to detect light in a second wavelength range that is different from the first wavelength range. None of the first photodetectors of the column of photodetectors may be adjacent to another of the first photodetectors, and none of the second photodetectors of the column of photodetectors may be adjacent to another of the second photodetectors. Each photodetector of the column of photodetectors may include an anode and a cathode. The anodes of the first photodetectors may be connected together. The cathodes of the first photodetectors may be connected together. The anodes of the second photodetectors may be connected together. The cathodes of the second photodetectors may be connected together. The first photodetectors may generate a single first output signal from the column of photodetectors. The second photodetectors may generate a single second output signal from the column of photodetectors.

In some aspects, the column of photodetectors may include third photodetectors configured to detect light in a third wavelength range that is different from the first and second wavelength ranges, and none of the third photodetectors of the column of photodetectors may be adjacent to another of the third photodetectors. In some aspects, the anodes of the third photodetectors may be connected together, and the cathodes of the third photodetectors may be connected together. In some aspects, the third photodetectors may generate a single third output signal from the column of photodetectors.

In some aspects, the sensor may further include one or more light sources, and the one or more light sources may be interleaved with the photodetectors of the photodetectors of the column of photodetectors.

In some aspects, the column of photodetectors may be a first column of photodetectors, and the sensor further include a second column of photodetectors. In some aspects, the second column of photodetectors may include first photodetectors configured to detect light in the first wavelength range and second photodetectors configured to detect light in the second wavelength range. In some aspects, none of the first photodetectors of the second column of photodetectors may be adjacent to another of the first photodetectors of the second column, and none of the second photodetectors of the second column of photodetectors may be adjacent to another of the second photodetectors of the second column.

In some aspects, the sensor may further include one or more light sources mounted on or fabricated in substrate. In some aspects, the one or more light sources may be interleaved with the photodetectors of the first and second columns of photodetectors.

These and other aspects encompassed within the systems and methods are described in the detailed description of the invention below.

### BRIEF DESCRIPTION OF THE DRAWINGS

The accompanying drawings, which are incorporated herein and form part of the specification, illustrate various, non-limiting aspects of the present invention. In the drawings, like reference numbers indicate identical or functionally similar elements.

FIG. 1 is a schematic view illustrating an analyte monitoring system according to some aspects.

FIG. 2A is a schematic view of an analyte sensor of the analyte monitoring system according to some aspects.

FIG. 2B is a schematic view illustrating an analyte sensor according to some aspects.

FIG. 2C is a schematic view illustrating an analyte sensor according to some aspects.

FIG. 2D is a schematic view of an analyte sensor of the analyte monitoring system according to some aspects.

FIG. 2E is an exploded view of an analyte sensor of the analyte monitoring system according to some aspects.

FIG. 2F is a perspective view of a housing and circuitry of an analyte sensor of the analyte monitoring system according to some aspects.

FIG. 2G is a top view of an assembled analyte sensor of the analyte monitoring system according to some aspects.

FIG. 3A is a top view of a substrate illustrating a layout of the light sources and photodetectors for two sensing areas of an analyte sensor according to some aspects.

FIG. 3B is a top view of a substrate illustrating a layout of the light sources and photodetectors for two sensing areas of an analyte sensor according to some aspects.

FIG. 3C illustrates a layout of the light sources and photodetectors for two sensing areas of an analyte sensor according to some aspects.

FIG. 3D is a side view of two sensing areas of an analyte sensor according to some aspects.

FIG. 4A illustrates a layout of the light sources and photodetectors for two sensing areas of an analyte sensor according to some aspects.

FIG. 4B is a side view of two sensing areas of an analyte sensor according to some aspects.

FIG. 4C is a top view of a substrate illustrating a layout of the light sources and photodetectors for two sensing areas of an analyte sensor according to some aspects.

FIG. 4D is a top view of a substrate illustrating a layout of the light sources and photodetectors for one sensing area of an analyte sensor according to some aspects, and FIG. 4E is a top view of the substrate illustrating a layout of the light sources and photodetectors for another sensing area of the analyte sensor according to some aspects.

FIG. 4F is a top view of a substrate illustrating a layout of the light sources and photodetectors for one sensing area of an analyte sensor according to some aspects, and FIG. 4G is a top view of the substrate illustrating a layout of the light sources and photodetectors for another sensing area of the analyte sensor according to some aspects.

FIG. 4H is a top view of a substrate illustrating a layout of the light sources and photodetectors for two sensing areas of an analyte sensor according to some aspects.

FIG. 4I is a top view of a substrate illustrating a layout of the light sources and photodetectors for two sensing areas of an analyte sensor according to some aspects.

FIG. 4J is a top view of a substrate illustrating a layout of the light sources and photodetectors for two sensing areas of an analyte sensor according to some aspects.

FIG. 4K is a top view of a substrate illustrating a layout of the photodetectors for two sensing areas of an analyte sensor according to some aspects.

FIG. 5 is a schematic view illustrating an exemplary transceiver of the analyte monitoring system according to some aspects.

FIG. 6 is a schematic view illustrating an exemplary display device of the analyte monitoring system according to some aspects.

FIG. 7 is a schematic view illustrating an exemplary computer of the system according to some aspects.

FIG. 8 is a flowchart illustrating a process according to some aspects.

### DETAILED DESCRIPTION OF PREFERRED ASPECTS

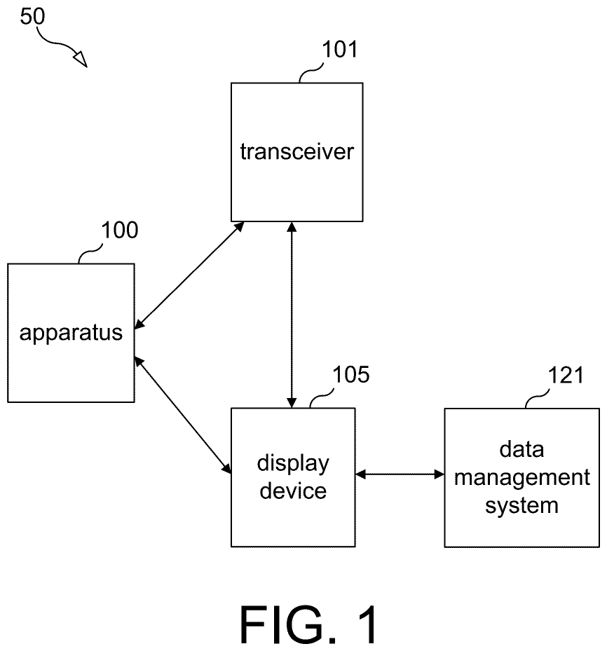

FIG. 1 is a schematic view of an exemplary analyte monitoring system 50 embodying aspects of the present invention. In some aspects, the analyte monitoring system 50 may be a continuous analyte monitoring system (e.g., a continuous glucose monitoring system). In some aspects, the analyte monitoring system 50 may include an analyte sensor 100, a transceiver 101, a display device 105, and/or a data management system (DMS) 121. In some aspects, the DMS 121 may be hosted by a remote server or network attached storage hardware.

In some aspects, the analyte sensor 100 may be an implantable device. In some aspects, the analyte sensor 100 may be a wireless implantable device. In some aspects, the analyte sensor 100 may include one or more optical sensors (e.g., one or more fluorometers). In some aspects, the analyte sensor 100 may be chemical or biochemical sensors. In some aspects, the analyte sensor 100 may be a radio frequency identification (RFID) device. In some aspects, the analyte sensor 100 may be a small, fully implantable (e.g., subcutaneously implantable) sensor that detects the presence, amount, and/or concentration of an analyte (e.g., glucose, oxygen, cardiac markers, low-density lipoprotein (LDL), high-density lipoprotein (HDL), or triglycerides) in a medium (e.g., interstitial fluid) of a living animal (e.g., a living human). However, this is not required, and, in some alternative aspects, the analyte sensor 100 may be a partially implantable (e.g., transcutaneous) device or a fully external sensor.

In some aspects, the transceiver 101 may be an externally worn transceiver (e.g., attached via an armband, wristband, waistband, or adhesive patch). In some aspects, the transceiver 101 may remotely power and/or communicate with the analyte sensor 100 to initiate and receive the measurements (e.g., via near field communication (NFC) or far field communication). However, this is not required, and, in some alternative aspects, the transceiver 101 may power and/or communicate with the analyte sensor 100 via one or more wired connections. In some aspects, the transceiver 101 may be a smartphone (e.g., an NFC-enabled smartphone). In some aspects, the transceiver 101 may communicate information (e.g., one or more analyte concentrations) wirelessly (e.g., via a Bluetooth™ communication standard such as, for example and without limitation Bluetooth Low Energy) to a mobile medical application running on a display device 105 (e.g., a smartphone such as, for example, an NFC-enabled smartphone). In some aspects, the analyte monitoring system 50 may include a web interface for plotting and sharing of uploaded data.

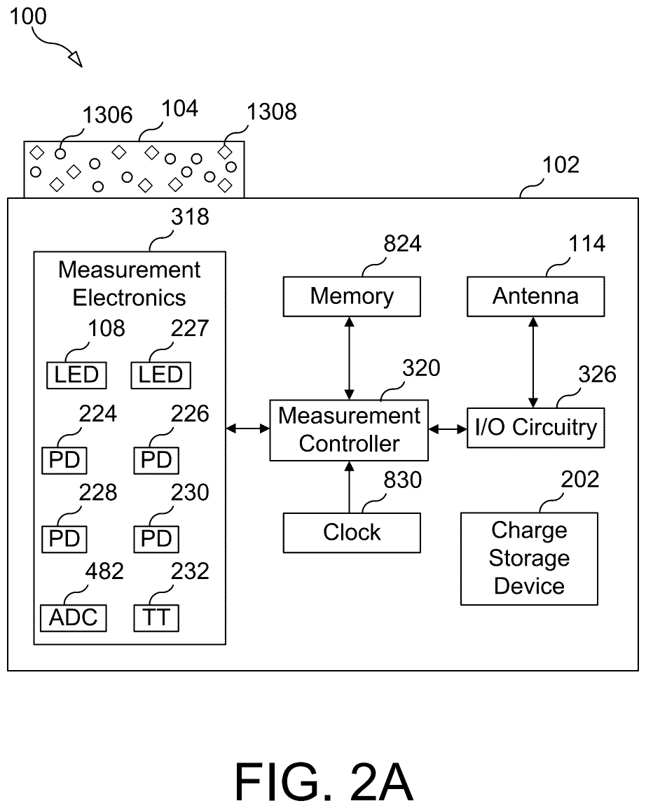

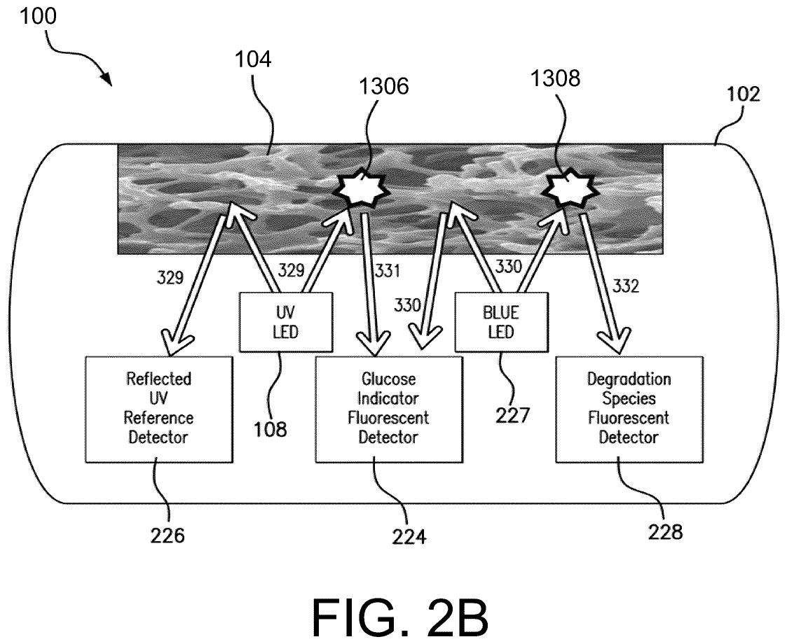

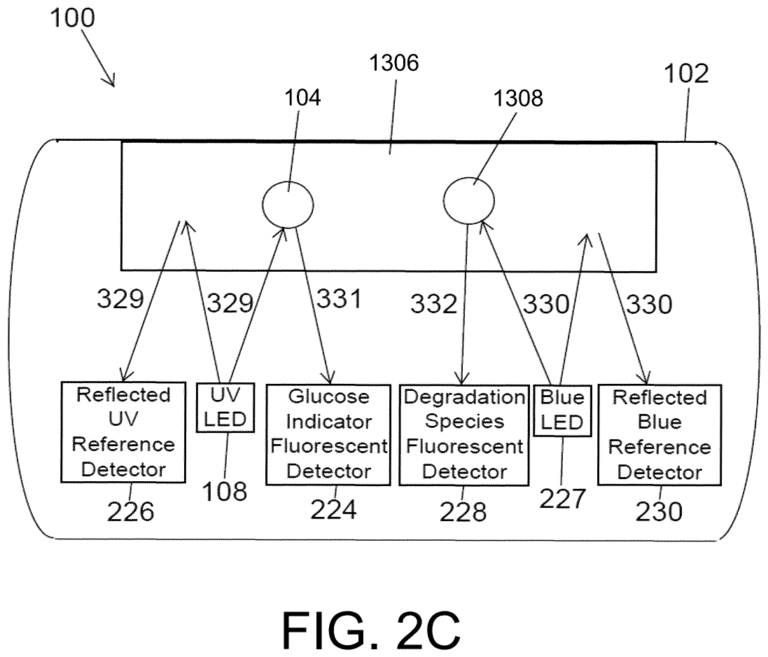

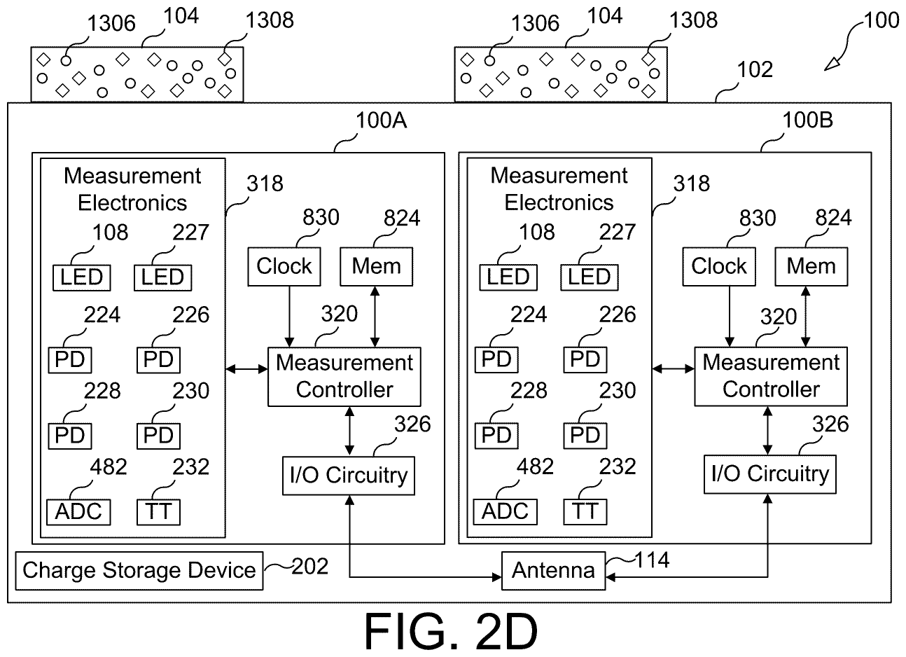

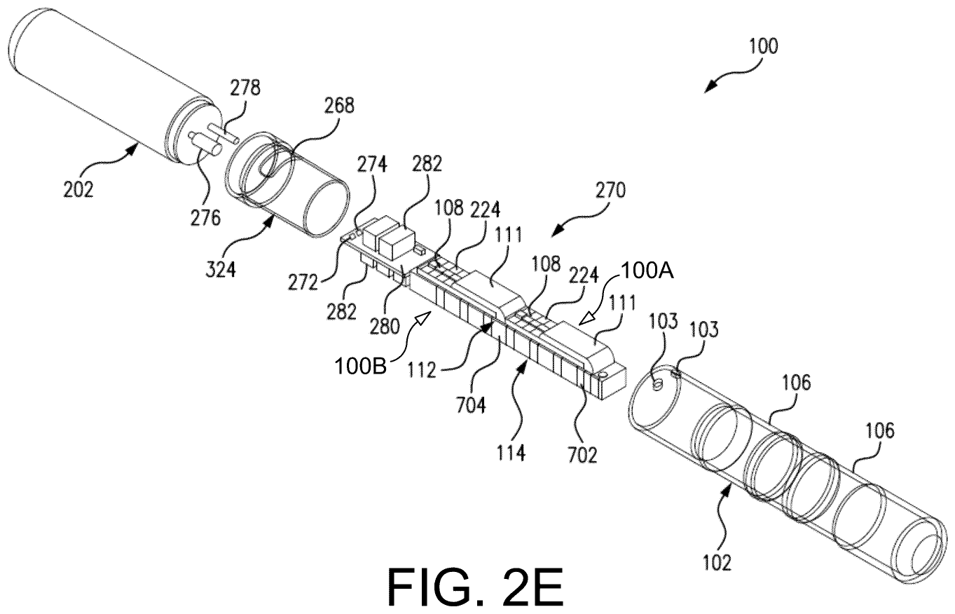

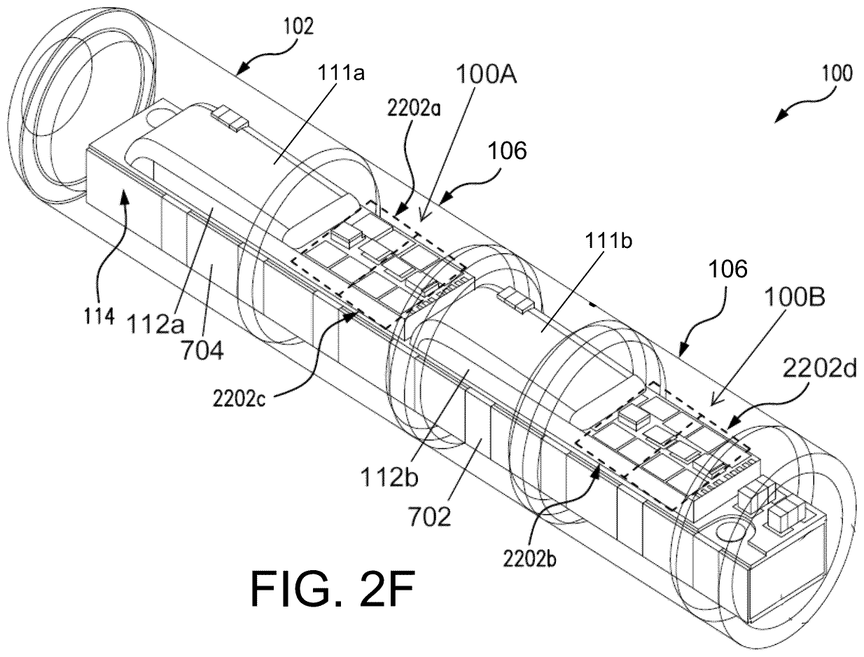

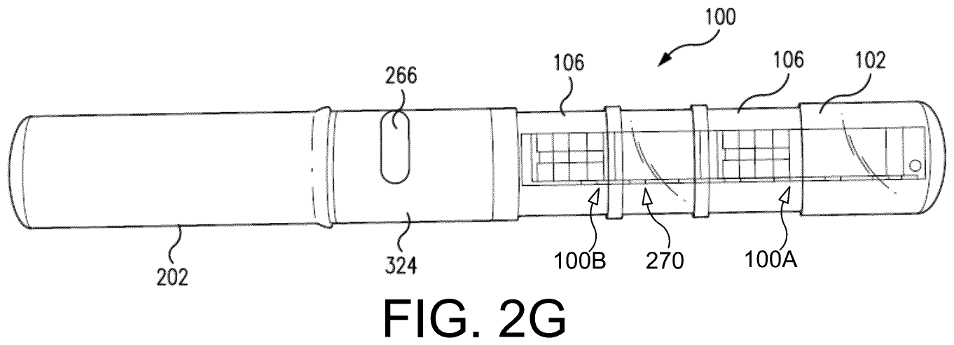

In some aspects, as shown in FIGS. 2A-2G, the analyte sensor 100 may include a housing 102 (i.e., body, shell, capsule, or encasement), which may be rigid and biocompatible. In some aspects, the housing 102 may be a silicon tube. However, this is not required, and, in other aspects, different materials and/or shapes may be used for the housing 102. In some aspects, the analyte sensor 100 may include a transmissive optical cavity (e.g., within the housing 102). In some aspects, the transmissive optical cavity may be formed from a suitable, optically transmissive polymer material, such as, for example, acrylic polymers (e.g., polymethylmethacrylate (PMMA)). However, this is not required, and, in other aspects, different materials may be used for the transmissive optical cavity.

In some aspects, as shown in FIGS. 2A-2D, the analyte sensor 100 may include analyte and/or interferent indicator material 104, which may be, for example, polymer grafts or hydrogels coated, diffused, adhered, embedded, or grown on or in one or more portions of the exterior surface of the housing 102. In some aspects, the analyte and/or interferent indicator material 104, may be porous and may allow the analyte (e.g., glucose) in a medium (e.g., interstitial fluid) to diffuse into the analyte and/or interferent indicator material 104.

In some aspects, as shown in FIGS. 2A-2D, the analyte and/or interferent indicator material 104 may include analyte indicator molecules 1306 and/or interferent indicator molecules 1308 (e.g., degradation indicator molecules). In some aspects, the analyte sensor 100 may use the analyte indicator molecules 1306 to measure the presence, amount, and/or concentration of an analyte (e.g., glucose, oxygen, cardiac markers, low-density lipoprotein (LDL), high-density lipoprotein (HDL), or triglycerides). In some aspects, the analyte sensor 100 may use the interferent indicator molecules 1308 to measure in vivo (e.g., ROS induced) signal degradation. In some aspects, in the analyte and/or interferent indicator material 104, the analyte indicator molecules 1306 and/or the interferent indicator molecules 1308 may be copolymerized into a single biocompatible hydrogel. In some aspects, the analyte indicator molecules 1306 and/or the interferent indicator molecules 1308 may have negligible spectral overlap and undergo similar degradation (e.g., similar degradation of boronic acids) in vivo.

In some aspects, the analyte indicator molecules 1306 may have one or more detectable properties (e.g., optical properties) that vary in accordance with (i) the amount or concentration of the analyte in proximity to the analyte and/or interferent indicator material 104 and (ii) an effect on the analyte indicator molecules 1306 (e.g., changes to the analyte indicator molecules 1306). In some aspects, the changes to the analyte indicator molecules 1306 may comprise the extent to which the analyte indicator molecules 1306 have degraded. In some aspects, the degradation may be (at least in part) ROS-induced oxidation. In some aspects, the analyte indicator molecules 1306 may be fluorescent analyte indicator molecules. In some aspects, the analyte indicator molecules 1306 may be distributed throughout the analyte and/or interferent indicator material 104. In some aspects, the analyte indicator molecules 1306 may be phenylboronic-based analyte indicator molecules. However, a phenylboronic-based analyte indicator is not required, and, in some alternative aspects, the analyte sensor 100 may include different analyte indicator molecules, such as, for example and without limitation, glucose oxidase-based indicators, glucose dehydrogenase-based indicators, and glucose binding protein-based indicators.

In some aspects, the interferent indicator molecules 1308 may have one or more detectable properties (e.g., optical properties) that vary in accordance with changes to the interferent indicator molecules 1308. In some aspects, the interferent indicator molecules 1308 are not sensitive to the amount of concentration of the analyte in proximity to the analyte and/or interferent indicator material 104. That is, in some aspects, the one or more detectable properties of the interferent indicator molecules 1308 do not vary in accordance with the amount or concentration of the analyte in proximity to the analyte and/or interferent indicator material 104. However, this is not required, and, in some alternative aspects, the one or more detectable properties of interferent indicator molecules 1308 may vary in accordance with the amount or concentration of the analyte in proximity to the analyte and/or interferent indicator material 104.

In some aspects, the changes to the interferent indicator molecules 1308 may comprise the extent to which the interferent indicator molecules 1308 have degraded. In some aspects, the degradation may be (at least in part) ROS-induced oxidation. In some aspects, the interferent indicator molecules 1308 may be fluorescent interferent indicator molecules. In some aspects, the interferent indicator molecules 1308 may be distributed throughout the analyte and/or interferent indicator material 104. In some aspects, the interferent indicator molecules 1308 may be phenylboronic-based interferent indicator molecules. However, phenylboronic-based interferent indicator molecules are not required, and, in some alternative aspects, the analyte sensor 100 may include different interferent indicator molecules 1308, such as, for example and without limitation, amplex red-based interferent indicator molecules, dichlorodihydrofluorescein-based interferent indicator molecules, dihydrorhodamine-based interferent indicator molecules, and scopoletin-based interferent indicator molecules.

In some aspects, the analyte monitoring system 50 may use the interferent indicator molecules 1308 of the analyte and/or interferent indicator material 104, which may by sensitive to degradation by reactive oxygen species (ROS) but not sensitive to the analyte, to measure indirectly changes to the analyte indicator molecules 1306 of an analyte and/or interferent indicator material 104. In some aspects, the interferent indicator molecules 1308 may have one or more optical properties that change with extent of oxidation and may be used as a reference for measuring and correcting for extent of oxidation of the analyte indicator molecules 1306. In some aspects, the extent to which the interferent indicator molecules 1308 have degraded may correspond to the extent to which the analyte indicator molecules 1306 have degraded. For example, in aspects, the extent to which the interferent indicator molecules 1308 have degraded may be proportional to the extent to which the analyte indicator molecules 1306 have degraded. In some aspects, the extent to which the analyte indicator molecules 1306 have degraded may be calculated based on the extent to which the interferent indicator molecules 1308 have degraded. In some aspects, the analyte monitoring system 50 may correct for changes in the analyte indicator molecules 1306 (e.g., using an empiric correlation established through laboratory testing).

In some aspects, as shown in FIG. 2A, the analyte sensor 100 may include measurement electronics 318 (e.g., optical measurement electronics). In some aspects, the measurement electronics 318 may include one or more light sources (e.g., light emitting diodes (LEDs)) and/or one or more photodetectors (e.g., photodiodes, phototransistors, photoresistors, or other photosensitive elements)). For example, in some aspects, as shown in FIGS. 2A-2C, the measurement electronics 318 may include one or more first light sources 108 that emit first excitation light 329 over a wavelength range that interacts with the analyte indicator molecules 1306 in the analyte and/or interferent indicator material 104. In some aspects, the first excitation light 329 may be ultraviolet (UV) light. In some aspects, as shown in FIGS. 2A-2C, the analyte sensor 100 may include one or more second light sources 227 that emit second excitation light 330 over a wavelength range that interacts with the interferent indicator molecules 1308 in the analyte and/or interferent indicator material 104. In some aspects, the second excitation light 330 may be, for example and without limitation, blue light.

In some aspects, the analyte indicator molecules 1306 may emit first emission light 331 (e.g., fluorescent light) when irradiated by the first excitation light 329. In some aspects, an analyte (e.g., glucose) may bind reversibly to some of the analyte indicator molecules 1306, and the amount of first emission light 331 emitted by an analyte indicator molecule 1306 may vary based on whether the analyte is bound to the analyte indicator molecule 1306. For example, when irradiated by the first excitation light 329, an analyte indicator molecule 1306 may emit a relatively large amount of first emission light 331 if the analyte is bound to analyte indicator molecule 1306 and may emit a relatively small amount of first emission light 331 (or no first emission light 331) if analyte is not bound to the analyte indicator molecule 1306. Therefore, the amount of first emission light 331 emitted by the analyte indicator molecules 1306 may vary based on the concentration of the analyte in proximity to the analyte and/or interferent indicator material 104. In some aspects, the amount of first emission light 331 emitted by the analyte indicator molecule 1306 may also vary based on an amount of interference (e.g., the extent to which the analyte indicator molecules 1306 have degraded).

In some aspects, the interferent indicator molecules 1308 may emit second emission light 332 (e.g., fluorescent light) when irradiated by the second excitation light 330. In some aspects, the amount of second emission light 332 emitted by the interferent indicator molecules 1308 may vary based on an amount of interference (e.g., the extent to which the interferent indicator molecules 1308 have degraded). In some aspects, the amount of second emission light 332 emitted by the interferent indicator molecules 1308 does not vary based on the concentration of the analyte in proximity to the analyte and/or interferent indicator material 104. In some aspects, degradation (e.g., oxidation) of the interferent indicator molecules 1308 may additionally or alternatively cause the absorption of the interferent indicator molecules 1308 (e.g., absorption of the second excitation light 330 by the interferent indicator molecules 1308) to change.

In some aspects, as shown in FIGS. 2A-2C, the measurement electronics 318 of the analyte sensor 100 may also include one or more photodetectors 224, 226, 228 (e.g., photodiodes, phototransistors, photoresistors, or other photosensitive elements). In some aspects, the measurement electronics 318 of the analyte sensor 100 may include one or more first photodetectors 224 sensitive to first emission light 331 (e.g., fluorescent light) emitted by the analyte indicator molecules 1306 such that a signal generated by a first photodetector 224 is indicative of the level of first emission light 331 of the analyte indicator molecules 1306 and, thus, the amount of analyte of interest (e.g., glucose). In some aspects, as shown in FIGS. 2A-2C, the measurement electronics 318 may include one or more second photodetectors 226 sensitive to first excitation light 329 that may be reflected from the analyte and/or interferent indicator material 104 such that a signal generated by a photodetector 226 in response thereto is indicative of the level of reflected first excitation light 329. In some aspects, as shown in FIGS. 2A-2C, the analyte sensor 100 may include one or more third photodetectors 228 sensitive to second emission light 332 (e.g., fluorescent light) emitted by the interferent indicator molecules 1308 such that a signal generated by a third photodetector 228 in response thereto is indicative of the level of second emission light 332 from the interferent indicator molecules 1308 and, thus, the amount of degradation (e.g., oxidation).

In some aspects, as shown in FIG. 2B, the one or more first photodetectors 224 may be sensitive to second excitation light 330 that may be reflected from the analyte and/or interferent indicator material 104. In this way, the one or more first photodetectors 224 may act as reference photodetectors when the one or more second light sources 227 are emitting second excitation light 330. However, it is not required that the one or more first photodetectors 224 act as reference photodetectors when the one or more second light sources 227 are emitting second excitation light 330. In some alternative aspects, as shown in FIG. 2C, the measurement electronics 318 of the analyte sensor 100 may include one or more fourth photodetectors 230 that act as reference photodetectors when the one or more second light sources 227 are emitting second excitation light 330. In some aspects, the one or more fourth photodetectors 230 may be sensitive to second excitation light 330 that may be reflected from the analyte and/or interferent indicator material 104 such that a signal generated by a fourth photodetector 230 in response thereto is indicative of the level of reflected second excitation light 330.

In some aspects, one or more of the photodetectors 224, 226, 228, 230 may be covered by one or more filters that allow only a certain subset of wavelengths of light to pass through and reflect (or absorb) the remaining wavelengths. In some aspects, one or more filters on the one or more first photodetectors 224 may allow only a subset of wavelengths corresponding to first emission light 331 and/or the reflected second excitation light 330. In some aspects, one or more filters on the one or more second photodetectors 226 may allow only a subset of wavelengths corresponding to the reflected first excitation light 329. In some aspects, one or more filters on the one or more third photodetectors 228 may allow only a subset of wavelengths corresponding to second emission light 332. In some aspects in which the analyte sensor 100 includes one or more fourth photodetectors 230, one or more filters on the one or more fourth photodetectors 230 may allow only a subset of wavelengths corresponding to the reflected second excitation light 330.

In some aspects, as shown in FIG. 2A, the measurement electronics 318 of the analyte sensor 100 may include one or more temperature transducers 232. In some aspects, the measurement electronics 318 may include one or more light source drivers, one or more amplifiers, one or more analog-to-digital convertors (ADCs) 482, one or more comparators, and/or one or more multiplexors. In some aspects, the one or more ADCs 482 may convert analog signals output by the photodetectors 224, 226, 228, 230 and/or one or more temperature transducers 232 to digital signals.

In some aspects, as shown in FIG. 2A, the analyte sensor 100 may include a charge storage device 202, a measurement controller 320, a memory 824, a clock 830, input/output (I/O) circuitry 326, and/or an antenna 114. In some aspects, the I/O circuitry 326 may include I/O digital circuitry and/or I/O analog circuitry. In some aspects, the antenna 114 may be electrically connected to the I/O circuitry 326, which may use current flowing through the antenna 114 to generate power for the analyte sensor 100 and/or to extract data from the current. In some aspects, the I/O circuitry 326 may also convey data (e.g., to the transceiver 101 and/or display device 105) by modulating the current flowing through the antenna 114. In some aspects, the I/O circuitry 326 may (at least at times) be electrically connected to and powered by the charge storage device 202.

In some aspects, when electrically connected to and powered by the charge storage device 202, the clock 830 may provide a continuous clock for driving circuitry of the analyte sensor 100 (e.g., even when the analyte sensor 100 is not receiving power from an external device such as the transceiver 101 and/or the display device 105). In some aspects, the measurement controller 320 may be a computer. In some aspects, the analyte sensor 100 may use the continuous clock output of the clock 830 to keep track of time and initiate autonomous, self-powered analyte measurements when appropriate (e.g., at periodic intervals, such as, for example, every minute, every two minutes, every 5 minutes, every 10 minutes, every 15 minutes, every half-hour, every hour, every two hours, every six hours, every twelve hours, or every day). In some aspects, the measurement controller 320 may control the measurement electronics 318 to perform an autonomous analyte measurement sequence, and the results of the autonomous analyte measurement may be stored in the memory 824. The autonomous analyte measurements may be stored in the memory 824. In some aspects, the I/O circuitry 326 may convey one or more of the stored measurements to the external device (e.g., the transceiver 101 and/or the display device 105) at a later time. For example, in some request aspects, the I/O circuitry 326 may convey one or more of the stored measurements in response to the analyte sensor 100 receiving and decoding a measurement data request from the transceiver 101 and/or the display device 105. In some alternative aspects, the I/O circuitry 326 may convey one or more of the stored measurements in response to detecting that the transceiver 101 and/or display device 105 is present (e.g., when an electrodynamic field generated by the transceiver 101 and/or display device 105 induces a current in the antenna 114 of the analyte sensor 100).

In some aspects, the memory 824 may be a nonvolatile storage medium. In some aspects, the memory 824 may be an electrically erasable programmable read only memory (EEPROM). However, in some alternative aspects, other types of nonvolatile storage media, such as flash memory, may be used. In some aspects, the memory 824 may include an address decoder. In some aspects, the memory 824 may store measurement information autonomously generated while the analyte sensor 100 is powered from the charge storage device 202. In some aspects, the memory 824 may additionally or alternatively store one or more time-stamps identifying when the measurement data was generated, sensor calibration data, a unique sensor identification, setup information, and/or integrated circuit calibration data. In some aspects, the unique identification information may, for example, enable full traceability of the analyte sensor 100 through its production and subsequent use.

In some aspects, as shown in FIG. 2A, the analyte sensor 100 may include one sensing device, which may include the measurement electronics 318 that interact with (e.g., emits excitation light to and detects light reflected and/or emitted by) the analyte and/or interferent indicator material 104. However, this is not required, and, in some alternative aspects, the analyte sensor 100 may include a different number of sensing devices (e.g., two, three, four, five, ten, etc.). For example, as shown in FIGS. 2D-2G, the analyte sensor 100 may include first and second sensing devices 100A and 100B. In some aspects, as shown in FIG. 2D, the sensing devices 100A and 100B may each include one or more measurement electronics 318 that interact with analyte and/or interferent indicator material 104 on a portion 106 of the exterior surface of the housing 102. In some aspects, as shown in FIG. 2D, the sensing devices 100A and 100B may share a charge storage device 202 and/or an antenna 114. That is, in some aspects in which the analyte sensor 100 includes multiple sensing devices, as shown in FIG. 2D, the antenna 114 may be electrically connected to the circuitry of the multiple sensing devices (e.g., sensing devices 100A and 100B), and the charge storage device 202 may be connected to the circuitry of the multiple sensing devices.

In some aspects, as shown in FIG. 2F, the analyte sensor 100 may include multiple sensing areas 2202 (e.g., sensing areas 2202a, 2202b, 2202c, and 2202d). In some aspects, as shown in FIG. 2F, the first sensing device 100A may include sensing areas 2202a and 2202c, and the second sensing device 100B may include sensing areas 2202b and 2202d. In some aspects, the analyte sensor 100 may include measurement electronics 318 (e.g., optical measurement electronics) for each of the sensing areas 2202. In some aspects, the measurement electronics 318 for each of the sensing areas 2202 may include one or more light sources (e.g., light sources 108 and 227) and/or one or more photodetectors (e.g., photodetectors 224, 226, 228, 230).

FIG. 2E is an exploded and assembled view of an analyte sensor 100 including first and second sensing devices 100A and 100B according to some aspects. FIG. 2F is perspective view of the housing 102 and circuitry 270 of an analyte sensor 100 including first and second sensing devices 100A and 100B according to some aspects. FIG. 2G is an assembled view of an analyte sensor 100 including first and second sensing devices 100A and 100B according to some aspects. In some aspects, as shown in FIG. 2E, the analyte sensor 100 may include the housing 102, circuitry 270, the charge storage device 202, first and second electrically conductive leads 276 and 278, and/or a coupler 324. In some aspects, as shown in FIG. 2G, a first end of the coupler 324 may be attached to the charge storage device 202. In some aspects, as shown in FIG. 2G, when assembled, the circuitry 270 may be at least partially within the housing 102. In some aspects, as shown in FIG. 2G, at least a portion of the housing 102 may extend into a second end of the coupler 324.

In some aspects, the circuitry 270 may include measurement electronics (e.g., optical measurement electronics), one or more circuit components 111 (e.g., analog and/or digital circuit components), the antenna 114, one or more capacitors 282, and/or first and second contact pads 272 and 274. In some aspects, the measurement electronics of the circuitry 270 may include one or more light sources (e.g., light sources 108 and 227) and/or one or more photodetectors (e.g., photodetectors 224, 226, 228, 230). In some aspects, the analyte sensor 100 may include the analyte indicator material 104 on or in one or more portions 106 of the exterior surface of the housing 102. In some aspects, as shown in FIGS. 2E-2G, the housing 102 may include one or more cutouts or recesses, and one or more portions 106 in or on which the analyte indicator material 104 is (partially or entirely) located may be in the cutouts or recesses.

In some aspects, as shown in FIGS. 2E and 2F, the analyte sensor 100 may include one or more substrates 112 (e.g., a first substrate 112a and a second substrate 112b as shown in FIG. 2E). In some aspects, the analyte sensor 100 may include one or more circuit components 111 (e.g., first circuit components 111a and second circuit components 111b as shown in FIG. 2F). In some aspects, as shown in FIG. 2F, the first sensing device 100A may include the first substrate 112a and the first circuit components 111a, and the second sensing device 100B may include the second substrate 112b and the second circuit components 111b. In some aspects, the circuit components 111 of a sensing device (e.g., the first circuit components 111a of the first sensing device 100A or the second circuit components 111b of the second sensing device 100B) may include the one or more ADCs 482 and/or the one or more temperature transducers 232 of measurements electronics 318, one or more measurement controllers 320, one or more clocks 830, one or more memories 824, and/or one or more I/O circuitries 326.

In some aspects, the one or more substrates 112 (e.g., the first substrate 112a and the second substrate 112b) may be circuit boards (e.g., a printed circuit boards (PCBs) or flexible PCBs) on which the one or more of the circuit components 111 (e.g., analog and/or digital circuit components) may be mounted or otherwise attached. However, in some alternative aspects, the substrates 112 may be semiconductor substrates having one or more of the circuit components 111 fabricated therein. For instance, the fabricated circuit components may include analog and/or digital circuitry. Also, in some aspects in which the one or more substrates 112 are semiconductor substrates, in addition to the circuit components fabricated in the one or more semiconductor substrate, circuit components may be mounted or otherwise attached to the one or more semiconductor substrate. In other words, in some semiconductor substrate aspects, a portion or all of the circuit components 111, which may include discrete circuit elements, an integrated circuit (e.g., an application specific integrated circuit (ASIC)) and/or other electronic components (e.g., a non-volatile memory), may be fabricated in the semiconductor substrate with the remainder of the circuit components 111 secured to the semiconductor substrate, which may provide communication paths between the various secured components.

In some aspects, as shown in FIGS. 2E and 2F, the measurement electronics of the circuitry 270 may be mounted on and/or fabricated in the one or more substrates 112. In some aspects, as shown in FIG. 2F, each of the sensing areas 2202a, 2202b, 2202c, and 2202d may include its own set of one or more light sources (e.g., light sources 108 and 227) and one or more photodetectors (e.g., photodetectors 224, 226, 228, 230) on a substrate 112. In some aspects, the one or more light sources 108 may be mounted on the one or more substrates 112, the one or more photodetectors 224 may be fabricated in the substrate 112, and all or a portion of the circuit components 111 may be fabricated within the substrate 112.

In some aspects, as shown in FIGS. 2E and 2F, the antenna 114 may be an inductor including a conductor 702 in the form of a coil and a magnetic core 704. In some aspects, the core 704 may be, for example and without limitation, a ferrite core. In some aspects, the antenna 114 may be, for example, a ferrite-based micro-antenna. In some aspects, as illustrated in FIGS. 2E and 2F, the one or more substrates 112 of the analyte sensor 100 may be attached to the antenna 114. In some aspects, the circuit components 111 of the substrates 112 may be connected electrically to the antenna 114. In some aspects, the analyte sensor 100 may use the antenna 114 to communicate data (e.g., measurement data) to the external device 101 and/or the display device 105. In some aspects, the analyte sensor 100 may use the antenna 114 for NFC.

In some aspects, as shown in FIG. 2E, the analyte sensor 100 may include a PCB 280. In some aspects, the one or more capacitors 282 of the circuitry 270 may be mounted on the PCB 280. In some aspects, the PCB 280 may include the first and second contact pads 272 and 274 of the circuitry 270. In some aspects, the circuit components 111 of the substrates 112 and/or the antenna 114 may be connected electrically to the one or more capacitors 282 and/or the first and second contact pads 272 and 274.

In some aspects, the analyte sensor 100 (e.g., the circuitry 270 of the analyte sensor 100) may be powered at least partially by the charge storage device 202. In some aspects, the charge storage device 202 may be a charge storage device (e.g., a battery, capacitor, or super capacitor). In some aspects, at least the exterior of the charge storage device 202 may be made of a biocompatible material such as, for example and without limitation, stainless steel or a titanium alloy. In some aspects, the charge storage device 202 may be a titanium-cased, hermetically-sealed battery. In some aspects, as shown in FIGS. 2E and 2G, the circuitry 270 of the analyte sensor 100 may extend away from the charge storage device 202 along the longitudinal axis of the charge storage device 202.

In some aspects, the charge storage device 202 may include first and second terminals (e.g., a positive terminal (cathode) and a negative terminal (anode)). In some aspects, the first and second electrically conductive leads 276 and 278 may be connected electrically to the first and second terminals, respectively, of the charge storage device 202. In some aspects, the electrically conductive leads 276 and 278 may electrically connect the first and second terminals, respectively, of the charge storage device 202 to the circuitry 270 of the analyte sensor 100. In some aspects, the electrically conductive leads 276 and 278 may be rods or beams including or made out of a conductive material.

In some aspects, as shown in FIGS. 2E and 2G, the coupler 324 may be a flange. In some aspects, as shown in FIG. 2G, the coupler 324 may be attached to the charge storage device 202. In some aspects, the coupler 324 may be welded (e.g., laser welded) to the charge storage device 202. In some aspects, the coupler 324 may enclose the first and second terminals of the charge storage device 202. In some aspects, as shown in FIG. 2G, the coupler 324 may be between the housing 102 and the charge storage device 202.

In some aspects, the coupler 324 may have a generally cylindrical shape. However, other shapes (e.g., a generally rectangular prism shape) may be used in alternative aspects. In some aspects, the coupler 324 may be made of a biocompatible material such as, for example and without limitation, glass, ceramic, stainless steel, titanium, or a titanium alloy. In some aspects, the coupler 324 may include a flat surface that abuts and is attached to the charge storage device 202.

In some aspects, as shown in FIG. 2E, the coupler 324 may include one or more openings 268 through which the first and second electrically conductive leads 276 and 278 are capable of being laser welded to the first and second contact pads 272 and 274, respectively, of the circuitry 270. In some aspects, the housing 102 may include one or more openings 103 through which the first and second electrically conductive leads 276 and 278 are capable of being laser welded to the first and second contact pads 272 and 274, respectively, of the circuitry 270. In some aspects, as shown in FIG. 2G, the analyte sensor 100 may further include a cap 266 over one or more openings 268 of the coupler 324.

In some aspects, the analyte sensor 100 may further include an encasement material that encases at least a first portion of the circuity 270 in the housing 102. In some aspects, the first portion of the circuitry 270 may include the one or more light sources and the one or more photodetectors. In some aspects, the encasement material may include a water-resistant epoxy. In some aspects, the excitation light emitted by the one or more light sources of the circuitry 270 may reach the analyte and/or interferent indicator material 104 on or in the one or more portions 106 of the housing 102 after passing through the encasement material. In some aspects, the emission light emitted by the analyte and/or interferent indicator material 104 may reach the one or more photodetectors after passing through the encasement material.

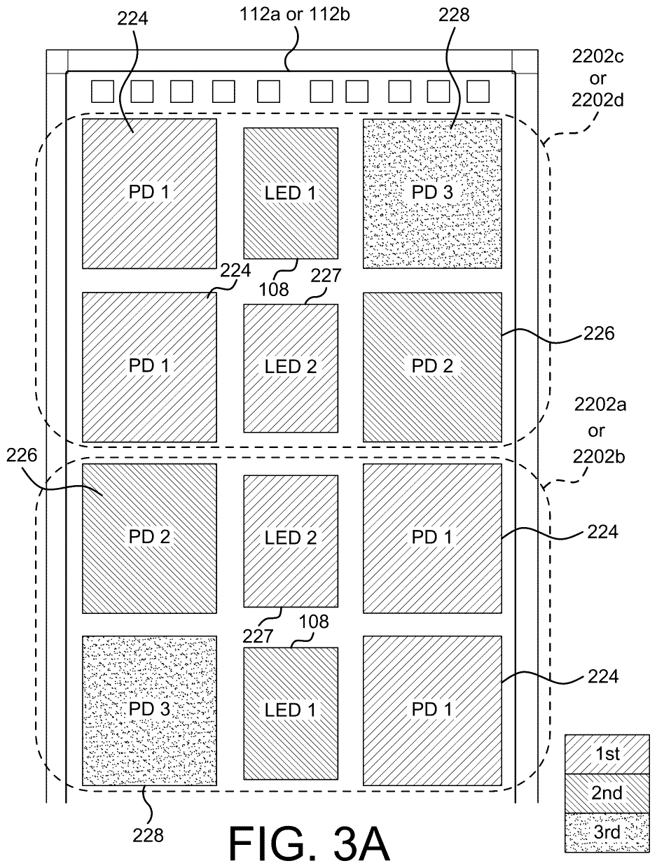

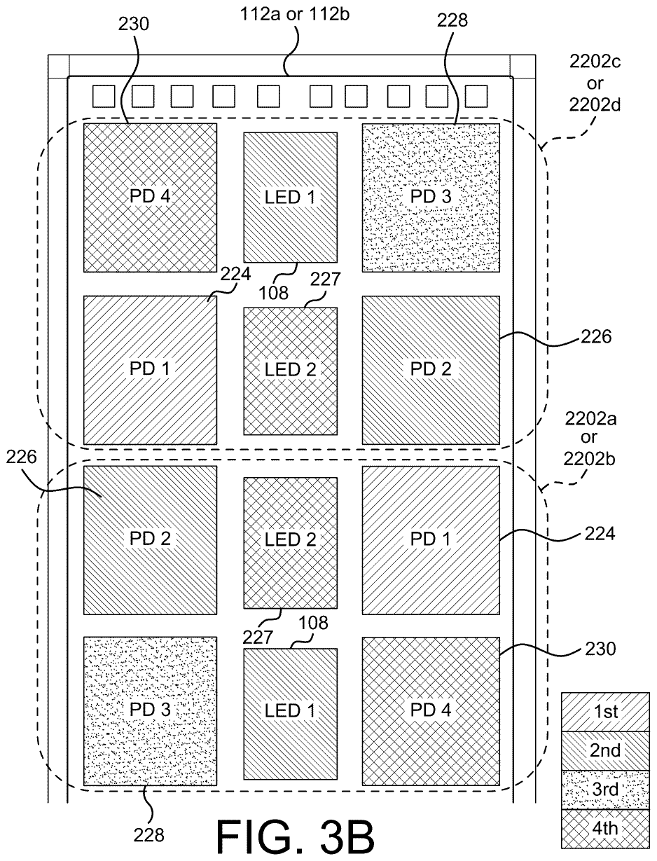

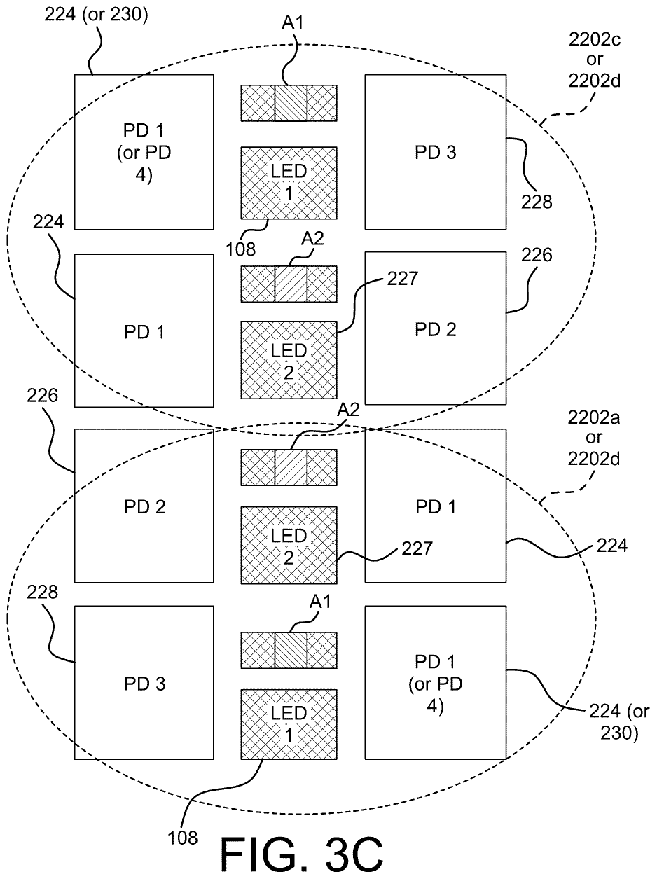

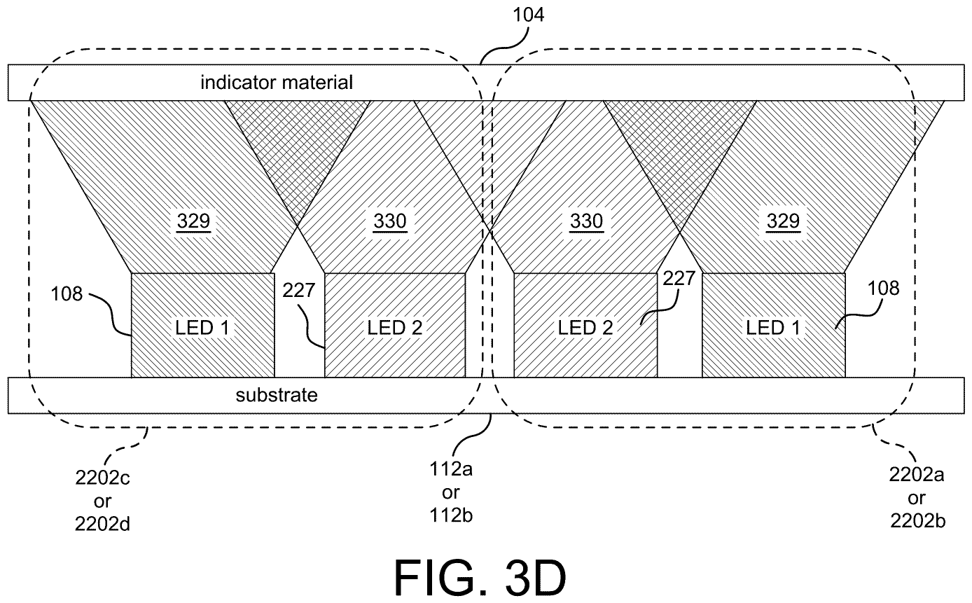

FIG. 3A shows the layout of the light sources 108 and 227 and photodetectors 224, 226, and 228 mounted on and/or fabricated in a substrate 112 of the analyte sensor 100 for two sensing areas 2202 according to some aspects in which each sensing area includes two light sources that emit light over different wavelength ranges and three photodetectors that detect light in different wavelength ranges. In particular, FIG. 3A shows the layout of the first and second light sources 108 and 227 and first, second, and third photodetectors 224, 226, and 228 mounted on and/or fabricated in first substrate 112a of the first sensing device 100A of the analyte sensor 100 for the sensing areas 2202a and 2202c (or in second substrate 112b of the second sensing device 100B of the analyte sensor 100 for the sensing areas 2202b and 2202d) according to some aspects. The different colors of the first and second light sources 108 and 227 and first, second, and third photodetectors 224, 226, and 228 in FIG. 3A may represent the different wavelength ranges of the light emitted or detected by the first and second light sources 108 and 227 and first, second, and third photodetectors 224, 226, and 228.

FIG. 3B shows the layout of the light sources 108 and 227 and photodetectors 224, 226, 228, 230 mounted on and/or fabricated in a substrate 112 of the analyte sensor 100 for two sensing areas 2202 according to some aspects in which each sensing area includes two light sources that emit light over different wavelength ranges and four photodetectors that detect light in different wavelength ranges. In particular, FIG. 3B shows the layout of the first and second light sources 108 and 227 and first, second, third, and fourth photodetectors 224, 226, 228, and 230 mounted on and/or fabricated in first substrate 112a of the first sensing device 100A of the analyte sensor 100 for the sensing areas 2202a and 2202c (or in second substrate 112b of the second sensing device 100B of the analyte sensor 100 for the sensing areas 2202b and 2202d) according to some aspects. The different colors of the first and second light sources 108 and 227 and first, second, and third photodetectors 224, 226, 228, and 230 in FIG. 3B may represent the different wavelength ranges of the light emitted or detected by the first and second light sources 108 and 227 and first, second, and third photodetectors 224, 226, 228, and 230.

In some aspects, as shown in FIG. 3C, the light sources 108 and 227 may include light emitting active areas. In particular, as shown in FIG. 3C, the first light sources 108 may include first light emitting active areas A1, and the second light sources 227 may include second light emitting active areas A2. In some aspects, as shown in FIG. 3C, the first and second light emitting active areas A1 and A2 in a sensing area 2202 may be separated from one another. In some aspects, as shown in FIG. 3D, the separation of the first and second light emitting active areas A1 and A2 in a sensing area 2202 may result in a small overlap between the portion of the analyte and/or interferent indicator material 104 irradiated by the first excitation light 329 emitted by the first light source 108 and the portion of the analyte and/or interferent indicator material 104 irradiated by the second excitation light 330 emitted by the second light source 227. That is, in some aspects, as shown in FIG. 3D, the separation of the first and second light emitting active areas A1 and A2 in a sensing area 2202 may result in the first and second light sources 108 and 227 of a sensing area 2202 irradiating substantially different portions of the analyte and/or interferent indicator material 104. In addition, as shown in FIGS. 3A-3D, the different photodetectors 224, 226, and 228 (or 224, 226, 228, and 230) of a sensing area 2202 may detect light reflected or emitted from different portions of the analyte and/or interferent indicator material 104.

However, it would be advantageous (e.g., in terms of increasing the accuracy of calculated analyte levels) if there were more overlap between the portions of the analyte and/or interferent indicator material 104 irradiated by the light sources 108 and 224 of a sensing area 2202 and/or if the different photodetectors 224, 226, and 228 (or 224, 226, 228, and 230) of the sensing area 2202 detected light reflected or emitted from same portion of the analyte and/or interferent indicator material 104. For example, degradation of the analyte and/or interferent indicator material 104 may not occur uniformly. As a result, one portion of the analyte and/or interferent indicator material 104 may have degraded more than another portion of the analyte and/or interferent indicator material 104. If the degradation of the analyte and/or interferent indicator material 104 in a sensing area 2202 is calculated based on a portion of the analyte and/or interferent indicator material 104 different than the portion of the analyte and/or interferent indicator material 104 on which the analyte level calculation is based, the calculated degradation may not accurately reflect the degradation of the analyte and/or interferent indicator material 104 in the portion on which the analyte level calculation is based.

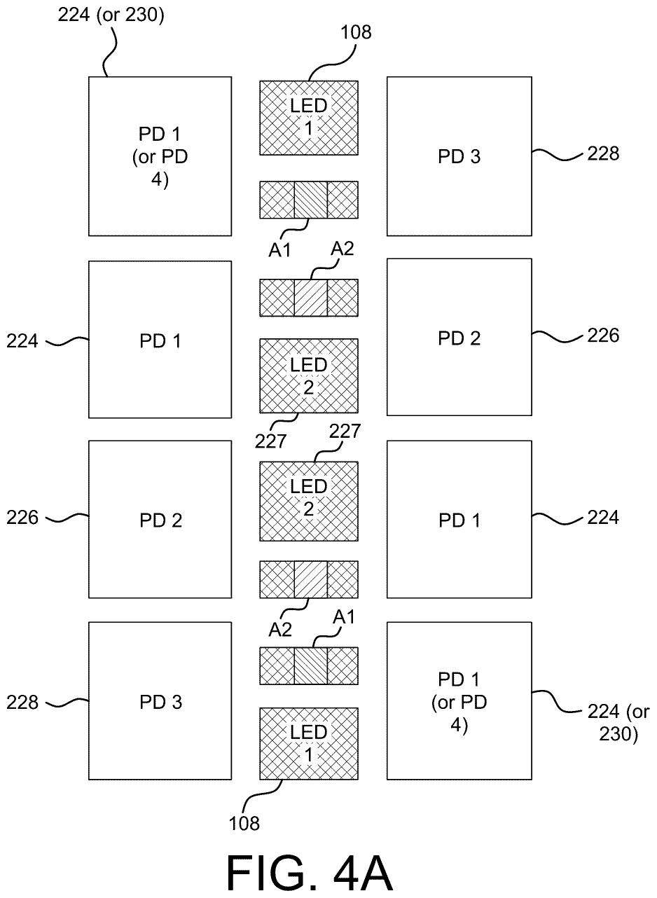

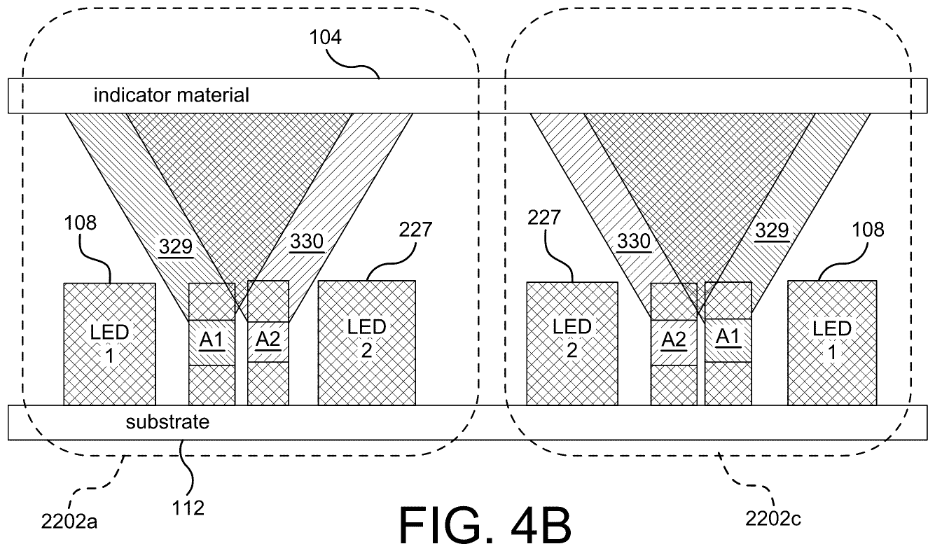

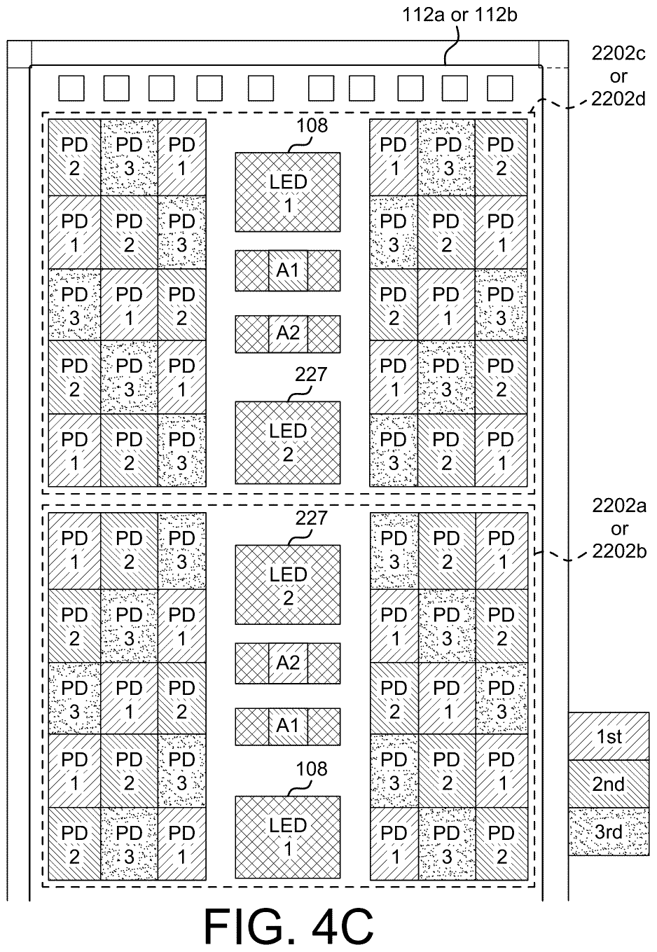

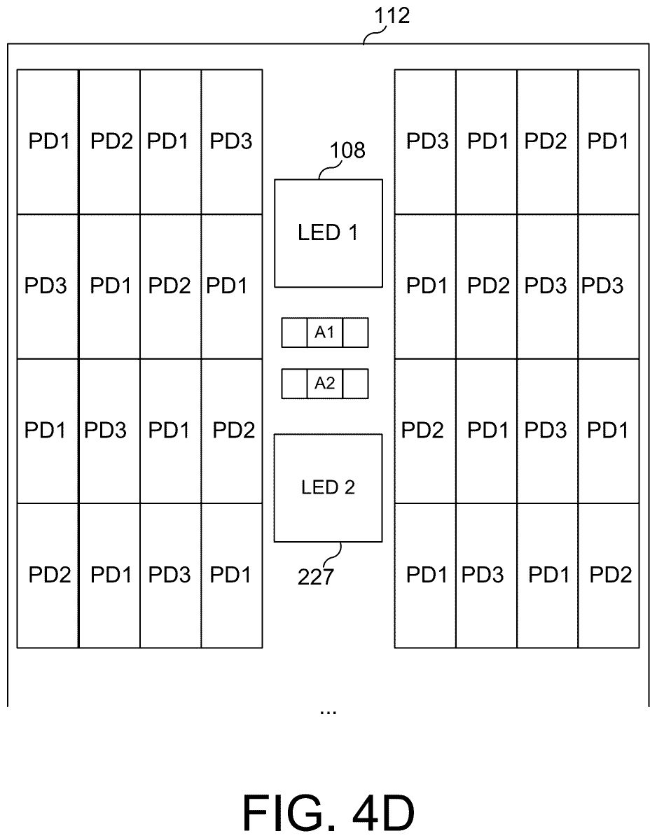

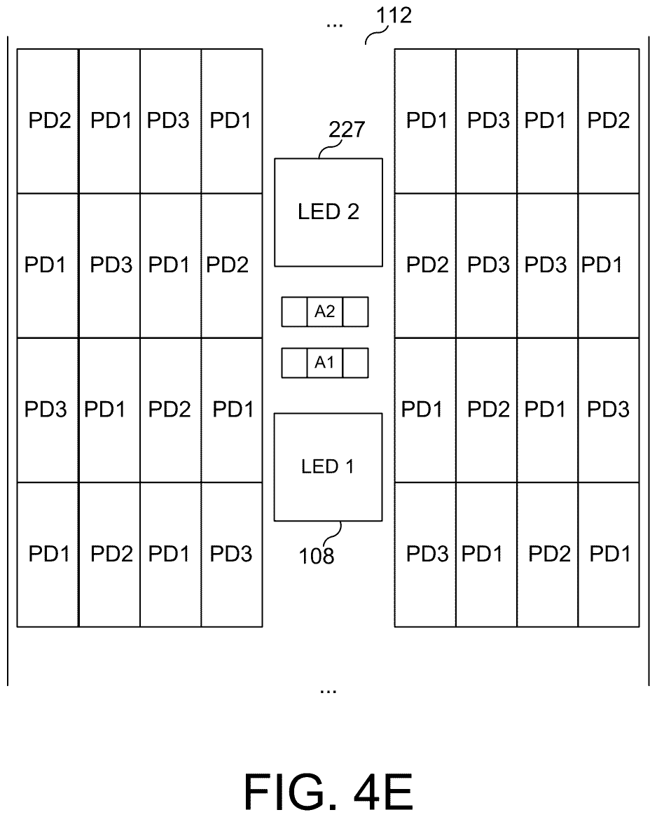

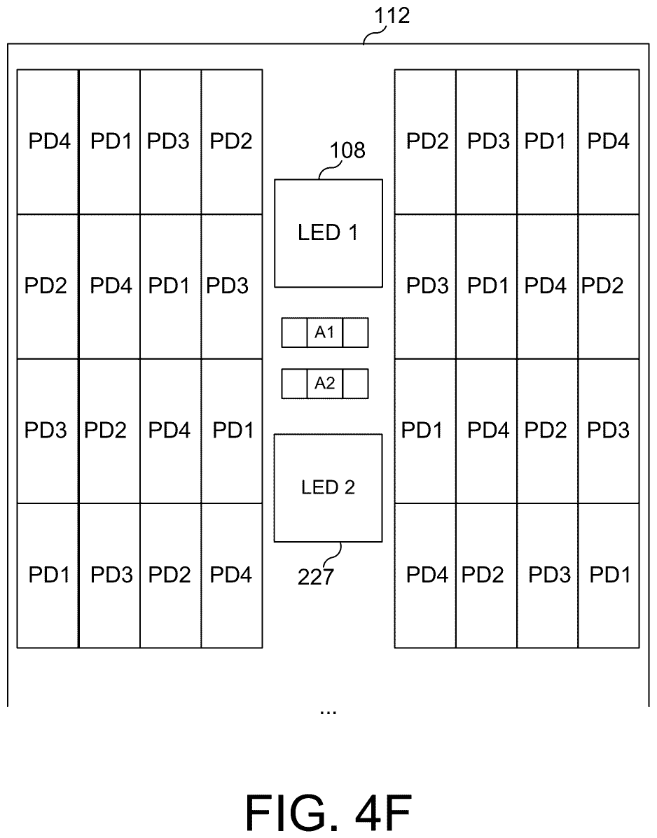

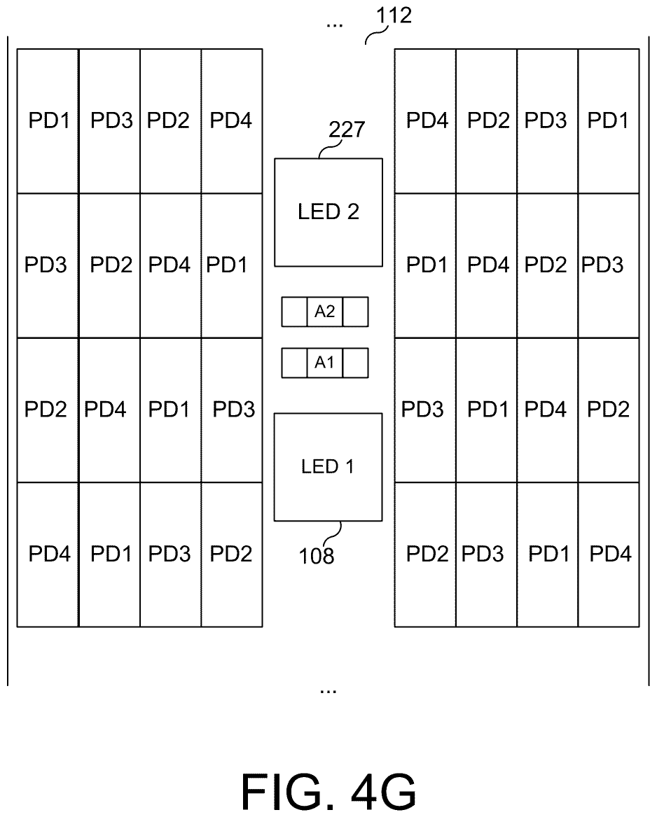

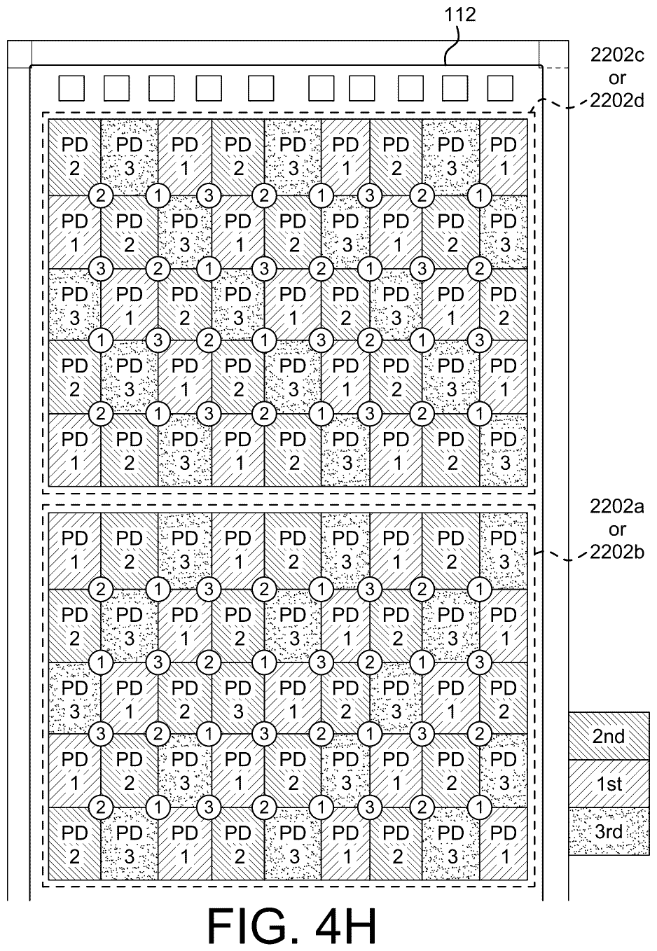

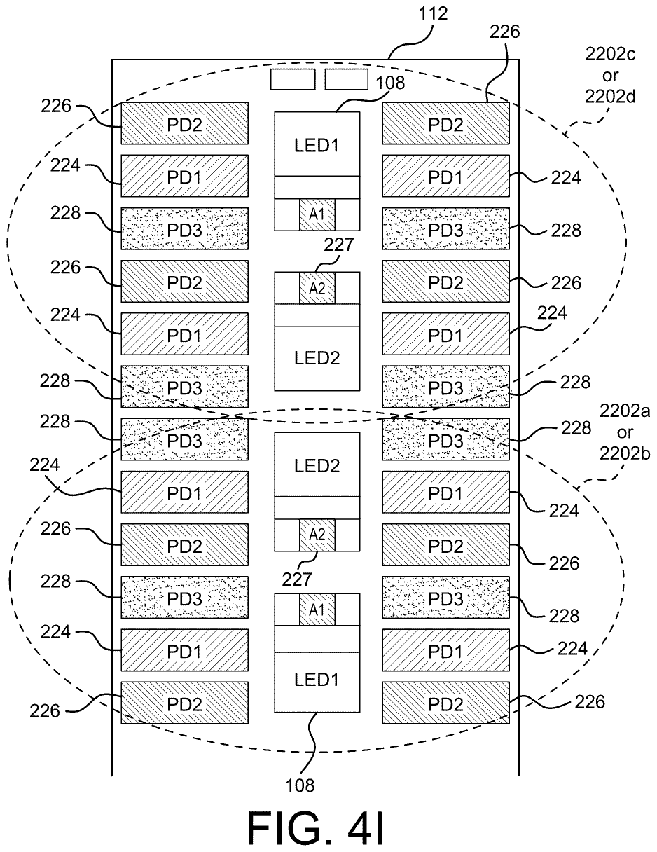

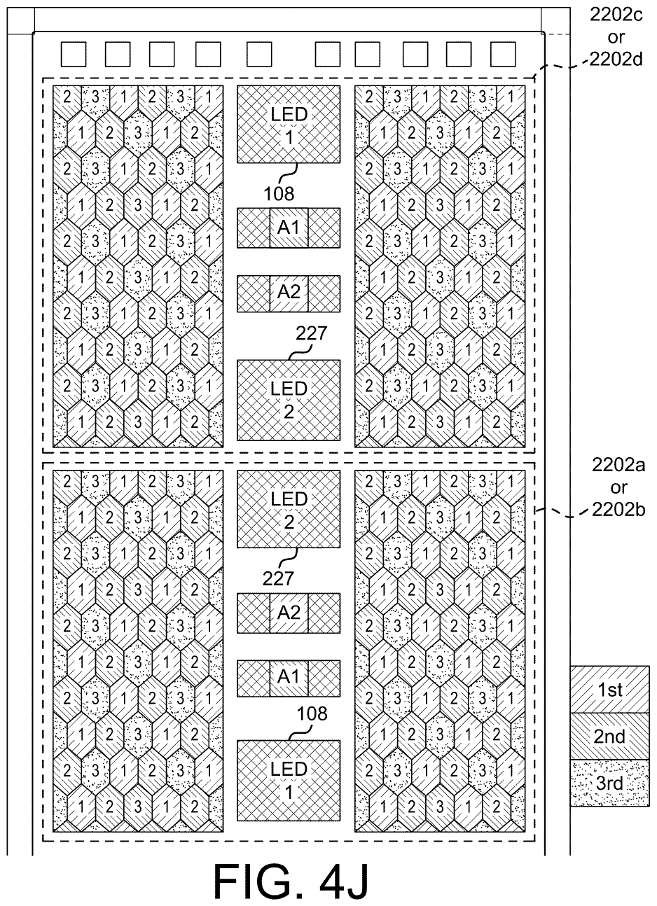

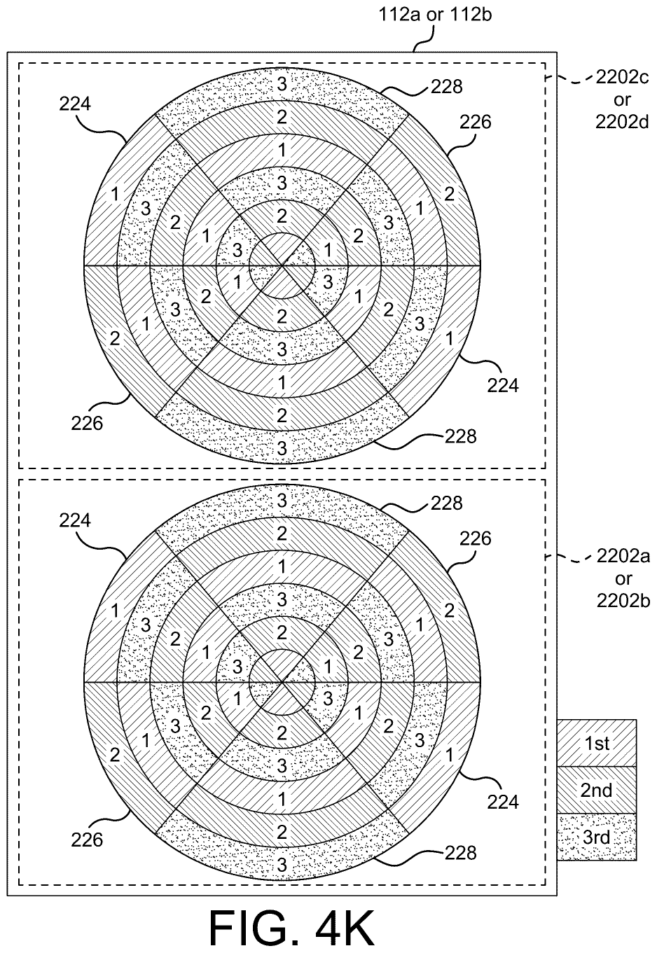

In some aspects, as shown in FIG. 4A, the first and second light emitting active areas A1 and A2 of the first and second light sources 108 and 227, respectively, may be co-located. In some aspects, the first light emitting active area A1 of the first light source 108 may be on a light emitting side of the first light source 108, and the second light emitting active area A2 of the second light source 227 may be on a light emitting side of the second light source 227. In some aspects, to co-locate the first and second light emitting active areas A1 and A2, the first and second light sources 108 and 227 may be arranged such that the light emitting sides of the first and second light sources 108 and 227 are adjacent to one another. In some aspects, the first and second light sources 108 may be arranged such that a first light emitting active area A1 of each of the first light sources 108 is adjacent with the second light emitting active area A2 of each the light sources 227, and the first and second light emitting active areas A1 and A2 are not separated by a light source (e.g., first light source 208 that is between the first and second light emitting active areas A1). In some aspects, as shown in FIG. 4B, the co-location of the first and second light emitting active areas A1 and A2 of the first and second light sources 108 and 227, respectively, in a sensing area 2202 may increase the overlap between the portion of the analyte and/or interferent indicator material 104 irradiated by the first excitation light 329 emitted by the first light source 108 and the portion of the analyte and/or interferent indicator material 104 irradiated by the second excitation light 330 emitted by the second light source 227. That is, in some aspects, as shown in FIG. 4B, the co-location of the first and second light emitting active areas A1 and A2 in a sensing area 2202 may result in the first and second light sources 108 and 227 of a sensing area 2202 irradiating substantially the same portion of the analyte and/or interferent indicator material 104. In some aspects, the increase in the overlap between the portions of the analyte and/or interferent indicator material 104 irradiated by the first and second light sources 108 and 227 of a sensing area 2202 may increase the accuracy of calculated analyte levels for the sensing area 2202 (e.g., after the analyte level calculation is corrected based on the calculated degradation for the sensing area 2202).

In some aspects, as shown in FIGS. 4C-4K, in addition to (or as an alternative to) co-locating the first and second light emitting active areas A1 and A2 of the first and second light sources 108 and 227 in each of the sensing areas 2202, the photodetectors (e.g., first, second, third, and/or fourth photodetectors 224, 226, 228, and/or 230) of a sensing area 2202 may be spatially distributed. That is, in some aspects, in each of the sensing areas, the photodetectors of the sensing area 2202 may be spread across the whole sensing area 2202 such that they are interleaved. In FIGS. 4C-4K, first, second, third, and fourth photodetectors 224, 226, 228, and 230 (if present) are identified as PD1, PD2, PD3, and PD4, respectively. In some aspects, the interleaved photodetectors may improve the accuracy of calculated analyte levels for the sensing area 2202 because the signals generated by the photodetectors of any one type (e.g., the first photodetectors 224 or the second photodetectors 226) are more representative of the sensing area 2202 as a whole than if the photodetectors were not interleaved (e.g., as shown in FIGS. 3A and 3B). That is, in some aspects, as the interleaved photodetectors of a sensing area 2202 are spread across the sensing area 2202, the photodetectors of any one type may receive light emitted from or reflected by a greater portion of the analyte and/or interferent indicator material 104 than if the photodetectors were not interleaved (e.g., as shown in FIGS. 3A and 3B).

FIGS. 4C and 4H-4K illustrates first, second, and third photodetectors 224, 226, and 228 mounted on and/or fabricated in a substrate 112 of the analyte sensor 100 for two sensing areas 2202 (e.g., first, second, and third photodetectors 224, 226, and 228 mounted on and/or fabricated in a first substrate 112a of the analyte sensor 100 for sensing areas 2202a and 2202c or first, second, and third photodetectors 224, 226, and 228 mounted on and/or fabricated in a second substrate 112b of the analyte sensor 100 for sensing areas 2202b and 2202d) according to some aspects. FIG. 4D illustrates first, second, and third photodetectors 224, 226, and 228 mounted on and/or fabricated in a substrate 112 (e.g., first substrate 112a or second substrate 112b) of the analyte sensor 100 for one sensing area 2202 (e.g., sensing area 2202c or 2202d) according to some aspects, and FIG. 4E illustrates first, second, and third photodetectors 224, 226, and 228 mounted on and/or fabricated in the substrate 112 of the analyte sensor 100 for another sensing area 2202 (e.g., sensing area 2202a or 2202b) according to some aspects. FIG. 4F illustrates first, second, third, and fourth photodetectors 224, 226, 228, and 230 mounted on and/or fabricated in a substrate 112 (e.g., first substrate 112a or second substrate 112b) of the analyte sensor 100 for one sensing area 2202 (e.g., sensing area 2202c or 2202d) according to some aspects, and FIG. 4G illustrates first, second, third, and fourth photodetectors 224, 226, 228, and 230 mounted on and/or fabricated in the substrate 112 of the analyte sensor 100 for another sensing area 2202 (e.g., sensing area 2202a or 2202b) according to some aspects.

In some aspects, as shown in FIGS. 4C-4K, a sensing area 2202 of the analyte sensor 100 may include one or more arrays of photodetectors mounted on or fabricated in the substrate 112. In some aspects, as shown in FIGS. 4C-4K, an array of photodetectors may include first photodetectors (PD1) 224 configured to detect light (e.g., first emission light 331) in a first wavelength range. In some aspects, as shown in FIGS. 4C-4K, the array of photodetectors may additionally or alternatively include second photodetectors (PD2s) 226 configured to detect light (e.g., first excitation light 329) in a second wavelength range that is different from the first wavelength range. In some aspects, as shown in FIGS. 4C-4K, the array of photodetectors may additionally or alternatively include third photodetectors (PD3s) 228 configured to detect light (e.g., second emission light 332) in a third wavelength range that is different from the first and second wavelength ranges. In some aspects, the first wavelength range may be 445 nm-525 nm, the second wavelength range may be 372 nm-394 nm, and the third wavelength range may be 570 nm-610 nm. However, this is not required, and, in some alternative aspects, the first, second, and third wavelength ranges may be different ranges. In some aspects (e.g. some aspects in which in the first emission light 331 and the second excitation light 330 are in different wavelength ranges), as shown in FIGS. 4F and 4G, the array of photodetectors may additionally or alternatively include fourth photodetectors (PD4s) 230 configured to detect light (e.g., second excitation light 330) in a fourth wavelength range that is different from the first, second, and third wavelength ranges.

In some aspects, as shown in FIGS. 4C-4K, the photodetectors (e.g., first, second, third, and/or fourth photodetectors 224, 226, 228, and/or 230) of an array of photodetectors may be spatially distributed throughout the array of photodetectors. In some aspects, as shown in FIGS. 4C-4K, the first, second, third, and/or fourth photodetectors 224, 226, 228, and/or 230 may be interleaved with one another. For example, in some aspects, as shown in FIGS. 4C-4K, the first photodetectors may be interleaved with the second, third, and/or fourth photodetectors 226, 228, and/or 230 (if present). In some aspects, in each of the arrays of photodetectors, none of the photodetectors of the array may be adjacent to another photodetector of the same type (e.g., none of the first photodetectors 224 of an array may be adjacent to another first photodetector 224 of the array). However, this is not required (and may not be possible in some aspects depending on the layout and the number of different types of photodetectors).

In some aspects, each of the photodetectors (e.g., first, second, third, and/or fourth photodetectors 224, 226, 228, and/or 230) may include an anode and a cathode. In some aspects, in each array of the one or more arrays of photodetectors, the anodes of the first photodetectors 224 of the array may be connected together, the cathodes of the first photodetectors 224 of the array may be connected together, the anodes of the second photodetectors 226 of the array may be connected together, and the cathodes of the second photodetectors 226 of the array may be connected together. In some aspects, in each array of the one or more arrays of photodetectors, the first photodetectors 224 of the array may generate a single first output signal from the array of photodetectors, and the second photodetectors 226 of the array may generate a single second output signal from the array of photodetectors. Similarly, in some aspects in which the one or more arrays include third photodetectors 228, the anodes of the third photodetectors 228 of the array may be connected together, the cathodes of the third photodetectors 228 of the array may be connected together, and the third photodetectors 228 of the array may generate a single third output signal from the array of photodetectors. Similarly, in some aspects in which the one or more arrays include fourth photodetectors 230, the anodes of the fourth photodetectors 230 of the array may be connected together, the cathodes of the fourth photodetectors 230 of the array may be connected together, and the fourth photodetectors 230 of the array may generate a single fourth output signal from the array of photodetectors.

In some aspects, as shown in FIG. 4J, the one or more arrays of photodetectors may be hexagonal arrays in which the photodetectors (e.g., first, second, third, and/or fourth photodetectors 224, 226, 228, and/or 230) have a hexagonal shape. However, this is not required, and, in some alternative aspects, one or more of the one or more arrays of photodetectors may have a different layout, and/or the photodetectors of the one or more arrays may have a different shape. For example, in some alternative aspects, the one or more arrays of photodetectors may be hexagonal arrays in which the photodetectors a circular, oval, rectangular, or square shape. For another example, in some alternative aspects, the one or more arrays of photodetectors may each have a concentric layout, and the photodetectors of the one or more arrays may have a ring or circular shape. For still another example, in some alternative aspects, as shown in FIG. 4K, the one or more arrays of photodetectors may each have a concentric layout, and the photodetectors of the one or more array may have a segmented ring or segmented circle shape. For yet another example, in some alternative aspects, as shown in FIGS. 4C-I, the one or more arrays of photodetectors may each have a grid layout including one or more rows and one or more columns, and the photodetectors of the one or more arrays may have a square, rectangular, or circular shape.

In some grid layout aspects, as shown in FIGS. 4C-4H, the one or more arrays of photodetectors may each include rows and columns. In some aspects, as shown in FIGS. 4C-4H, the photodetectors (e.g., first, second, third, and/or fourth photodetectors 224, 226, 228, and/or 230) of an array of photodetectors may be spatially distributed in the rows and the columns of the array of photodetectors. In some aspects, as shown in FIGS. 4C-4H, each row of the array of photodetectors may include at least one first photodetector 224, and each column of the array of photodetectors may include at least one first photodetector 224. In some aspects, as shown in FIGS. 4C-4E and 4H, at least one of the rows of the array and/or at least one of the columns of the array may include two or more of the first photodetectors 224 of the array. In some aspects, as shown in FIGS. 4C-4H, none of the first photodetectors 224 of the array of photodetectors may be adjacent to another of the first photodetectors 224.

In some aspects, as shown in FIGS. 4C-4H, each row of the array of photodetectors may include at least one second photodetector 226, and each column of the array of photodetectors may include at least one second photodetector 226. In some aspects, as shown in FIGS. 4C and 4H, at least one of the rows of the array and/or at least one of the columns of the array may include two or more of the second photodetectors 226 of the array. In some aspects, as shown in FIGS. 4C-4H, none of the second photodetectors 226 of the array of photodetectors may be adjacent to another of the second photodetectors 226.

In some aspects, as shown in FIGS. 4C-4H, each row of the array of photodetectors may include at least one third photodetector 228, and each column of the array of photodetectors may include at least one third photodetector 228. In some aspects, as shown in FIGS. 4C and 4H, at least one of the rows of the array and/or at least one of the columns of the array may include two or more of the third photodetectors 228 of the array. In some aspects, as shown in FIGS. 4C-4H, none of the third photodetectors 228 of the array of photodetectors may be adjacent to another of the third photodetectors 228.

In some aspects, as shown in FIGS. 4F and 4G, each row of the array of photodetectors may include at least one fourth photodetector 230, and each column of the array of photodetectors may include at least one fourth photodetector 230. In some aspects, although not shown in FIGS. 4C-4H, at least one of the rows of the array and/or at least one of the columns of the array may include two or more of the fourth photodetectors 230 of the array. In some aspects, as shown in FIGS. 4F and 4G, none of the fourth photodetectors 230 of the array of photodetectors may be adjacent to another of the fourth photodetectors 230.

In some aspects, as shown in FIGS. 4C-4G, each of the rows may include at least one of the first photodetectors 224 and at least one of the second photodetectors 226, and each of the columns may include at least one of the first photodetectors 224 and at least one of the second photodetectors 226, at least one of the rows and/or at least one of the columns includes two or more of the first photodetectors, at least one of the rows and/or at least one of the columns includes two or more of the second photodetectors, none of the first photodetectors of the array of photodetectors is adjacent to another of the first photodetectors, and none of the second photodetectors of the array of photodetectors is adjacent to another of the second photodetectors.

In some aspects, as shown in FIGS. 4C-4G and 4J, a sensing area 2202 of the analyte sensor 100 may include at least two arrays of photodetectors mounted on or fabricated in the substrate 112. In some aspects, as shown in FIGS. 4C-4G and 4J, a first of the arrays of photodetectors may be on one side of the one or more light sources 108 and 227 of the sensing area 2202, and a second of the arrays of photodetectors may be on an opposite side of the one or more light sources 108 and 227 of the sensing area 2202. That is, in some aspects, as shown in FIGS. 4C-4G and 4J, the one or more light sources 108 and 227 of the sensing area 2202 may be between the first and second arrays of photodetectors. However, this is not required, and, in some alternative aspects, as shown in FIG. 4H, a sensing area 2202 may include a single arrays of photodetectors.

In some aspects in which a sensing area 2202 includes multiple arrays of photodetectors, in the multiple arrays of a sensing area 2202, the anodes of the first photodetectors 224 of the multiple arrays of the sensing area 2202 may be connected together, the cathodes of the first photodetectors 224 of the multiple arrays of the sensing area 2202 may be connected together, the anodes of the second photodetectors 226 of the multiple arrays of the sensing area 2202 may be connected together, and the cathodes of the second photodetectors 226 of the multiple arrays of the sensing area 2202 may be connected together. In some aspects, in the multiple arrays of the photodetectors of a sensing area 2202, the first photodetectors 224 of the multiple arrays of the sensing area 2202 may generate a single first output signal from the sensing area 2202, and the second photodetectors 226 of the multiple arrays of the sensing area 2202 may generate a single second output signal from the sensing area 2202. Similarly, in some aspects in which the multiple arrays of a sensing area 2202 include third photodetectors 228, the anodes of the third photodetectors 228 of the multiple arrays may be connected together, the cathodes of the third photodetectors 228 of the array may be connected together, and the third photodetectors 228 of the array may generate a single third output signal from the multiple arrays of photodetectors of the sensing area 2202. Similarly, in some aspects in which the multiple arrays of a sensing area 2202 include fourth photodetectors 230, the anodes of the fourth photodetectors 230 of the multiple arrays of the sensing area 2202 may be connected together, the cathodes of the fourth photodetectors 230 of the multiple arrays of the sensing area 2202 may be connected together, and the fourth photodetectors 230 of the multiple arrays of the sensing area 2202 may generate a single fourth output signal from the multiple arrays of photodetectors of the sensing area 2202. In some aspects, because the photodetectors of the multiple arrays of photodetectors of a sensing area 2202 are spatially distributed throughout each of the multiple arrays of the sensing area 2202, the single output signals from the different types of photodetectors (e.g., the single first, second, third, and fourth output signals generated by the first, second, third, and fourth photodetectors of the array) of the sensing area 2202 may each be representative the sensing area 2202 as a whole.

In some aspects, as shown in FIG. 4H, the one or more light sources (e.g., first and second light sources 108 and 227) of a sensing area 2202 may be spatially distributed. That is, in some aspects, as shown in FIG. 4H, in each of the sensing areas 2202, the one or more light sources of the sensing area 2202 may be spread across the sensing area 2202 such that they are interleaved with the photodetectors (e.g., first, second, third, and/or fourth photodetectors 224, 226, 228, and/or 230). In some aspects in which a sensing area includes multiple light sources (e.g., first and second light sources 108 and 227), the light sources may additionally be interleaved with each other (e.g., such that none of the first light sources 108 is adjacent to another of the first light sources 108, and none of the second light sources 227 is adjacent to another of the second light sources 227). FIG. 4H shows an example in which first, second, and third light sources (shown as circles) are interleaved with the photodetectors and with each other. In some aspects, the interleaved light sources may improve the accuracy of calculated analyte levels for the sensing area 2202 because, as the light sources are spread across the sensing areas, the light (e.g., first and second excitation light 329 and 331) emitted by the different light sources (e.g., first and second light sources 108 and 227) illuminates substantially the same portion of the analyte and/or interferent indicator material 104.

In some aspects, as shown in FIG. 4I, the one or more arrays of photodetectors may each include a single column of photodetectors. In some aspects, as shown in FIG. 4I, the photodetectors (e.g., first, second, third, and/or fourth photodetectors 224, 226, 228, and/or 230) of a column of photodetectors may be spatially distributed. In some aspects, as shown in FIG. 4I, none of the first photodetectors (PD1) 224 of the column of photodetectors may be adjacent to another of the first photodetectors 224 of the column, and none of the second photodetectors (PD2) 226 of the column of photodetectors may be adjacent to another of the second photodetectors 226 of the column. In some aspects, as shown in FIG. 4I, none of the third photodetectors (PD3) 228 of the column of photodetectors may be adjacent to another of the third photodetectors 228 of the column.

In some aspects, as shown in FIG. 4I, a sensing area 2202 of the analyte sensor 100 may include one or more light sources (e.g., first and/or second light sources 108 and/or 227) mounted on or fabricated in a substrate 112. In some aspects, as shown in FIG. 4I, the sensing area 2202 may include two columns, the one or more light sources may be between a first of the columns and a second of the columns. In some alternative aspects, although not shown in FIG. 4I, the one or more light sources may be interleaved with the photodetectors of the one or more columns.

In some aspects, as shown in FIG. 4K, the one or more arrays of photodetectors may each segmented, concentric rings of photodetectors. In some aspects, as shown in FIG. 4K, the photodetectors (e.g., first, second, third, and/or fourth photodetectors 224, 226, 228, and/or 230) may be spatially distributed in the segments and rings. In some aspects, as shown in FIG. 4K, in each of the concentric rings, none of the first photodetectors (PD1) 224 of the ring of photodetectors may be adjacent to another of the first photodetectors 224 of the ring, and none of the second photodetectors (PD2) 226 of the ring of photodetectors may be adjacent to another of the second photodetectors 226 of the ring. In some aspects, as shown in FIG. 4K, in each of the concentric rings, none of the third photodetectors (PD3) 228 of the ring of photodetectors may be adjacent to another of the third photodetectors 228 of the ring. Similarly, as shown in FIG. 4K, in each of the radial segments, none of the first photodetectors (PD1) 224 of the segment may be adjacent to another of the first photodetectors 224 of the segment, and none of the second photodetectors (PD2) 226 of the segment of photodetectors may be adjacent to another of the second photodetectors 226 of the segment. In some aspects, as shown in FIG. 4K, in each of the radial segments, none of the third photodetectors (PD3) 228 of the segment of photodetectors may be adjacent to another of the third photodetectors 228 of the segment.

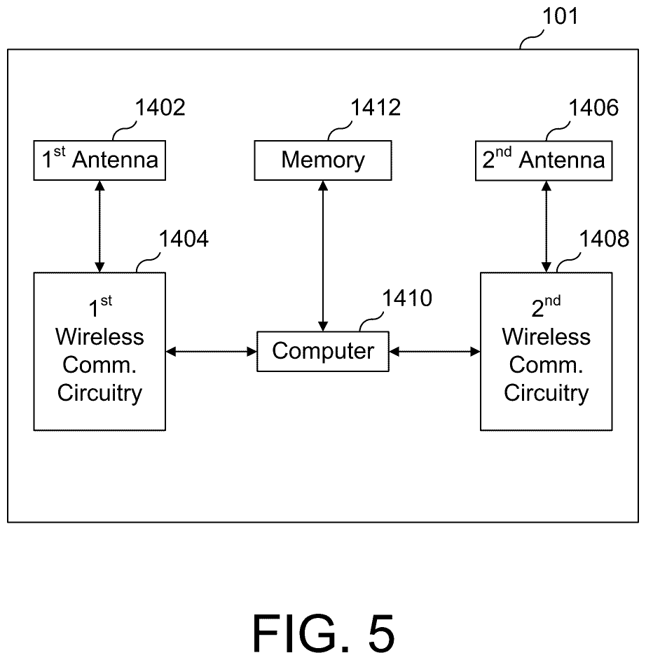

FIG. 5 illustrates an exemplary aspect in which the transceiver 101 of the system 50 is a wireless transceiver (e.g., a wireless on-body transceiver). However, this is not required, and, in some alternative aspects, the transceiver 101 may be a different type of transceiver (e.g., a transceiver having a wired connection to the apparatus 100). In some aspects, as shown in FIG. 3, the transceiver 101 may include a first antenna 1402, first wireless communication circuitry 1404, a second antenna 1406, second wireless communication circuitry 1408, a computer 1410, and/or a memory 1412. In some aspects, the computer 1410 may control the overall operation of the transceiver 101.

In some aspects, the transceiver 101 may include a sensor interface device. In some aspects, the sensor interface device of the transceiver 101 may include the first antenna 1402 and the first wireless communication circuitry 1404. In some aspects, the first wireless communication circuitry 1404 may enable the transceiver 101 to communicate directly with the apparatus 100. In some aspects, the transceiver 101 and the apparatus 100 may communicate using NFC (e.g. at a frequency of 13.56 MHz). In some aspects, the first antenna 1402 of the transceiver 101 may include an inductor (e.g. flat antenna, loop antenna, etc.) that is configured to permit adequate field strength to be achieved when brought within adequate physical proximity to the antenna 114 of the apparatus 100.

In some aspects, the transceiver 101 may use the first antenna 1402 and the first wireless communication circuitry 1404 to receive sensor data from the apparatus 100. In some aspects, the computer 1410 may store the received sensor data in the memory 1412. In some aspects, the memory 1412 may be non-volatile and/or capable of being electronically erased and/or rewritten. In some aspects, the memory 1412 may be, for example and without limitations a Flash memory.

In some aspects, the received sensor data may include light measurements, temperature measurements, and time stamps. In some aspects, the computer 1410 may use the sensor data to calculate analyte levels (e.g., blood glucose levels). In some aspects, calculating analyte levels may include calculating an individual analyte level for each sensing area 2202 of the analyte sensor 100 and calculating a combined analyte level based on at least the individual analyte levels (e.g., via weighted averaging of the individual analyte levels). In some aspects, the computer 1410 may store the calculated analyte levels in the memory 1412.

In some aspects, the transceiver 101 may include a display interface device. In some aspects, the display device interface device may include the second antenna 1406 and the second wireless communication circuitry 1408. In some aspects, the second wireless communication circuitry 1408 may enable wireless communication by the transceiver 101 with one or more external devices, such as, for example, one or more personal computers, one or more other transceivers 101, and/or display devices 105 via the second antenna 1406. In some aspects, the second wireless communication circuitry 1408 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1406 may be, for example and without limitation, a Bluetooth antenna.

In some aspects in which the transceiver 101 calculates analyte levels, the transceiver 101 may use the second antenna 1406 and the second wireless communication circuitry 1408 to convey calculated levels to the display device 105. In some aspects in which the transceiver 101 calculates and conveys analyte levels, the transceiver 101 may additionally convey the sensor data to the display device 105. In some alternative aspects, the transceiver 101 may not calculate analyte levels. In some aspects in which the transceiver 101 does not calculate analyte levels, the transceiver 101 may use the second antenna 1406 and the second wireless communication circuitry 1408 to convey sensor data to the display device 105, and the display device 105 may use the sensor data to calculate analyte levels.

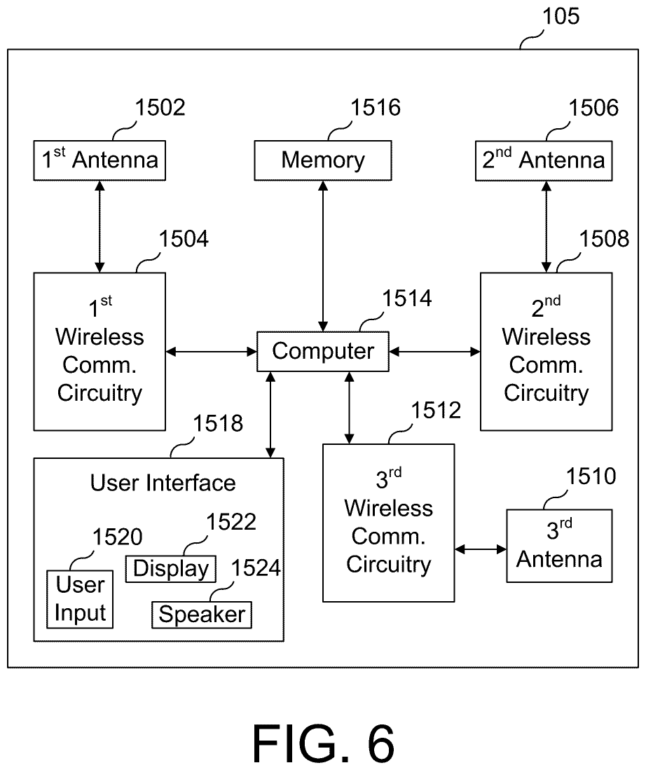

FIG. 6 is a block diagram of the display device 105 of the system 50 according to some aspects. In some aspects, as shown in FIG. 4, the display device 105 may include a first antenna 1502, first wireless communication circuitry 1504, second antenna 1506, second wireless communication circuitry 1508, third antenna 1510, third wireless communication circuitry 1512, a computer 1514, a memory 1516, and/or a user interface 1518. In some aspects, the computer 1514 may control the overall operation of the display device 105.

In some aspects, the display device 105 may include a sensor interface device. In some aspects, the sensor interface device of the display device 105 may include the first antenna 1502 and the first wireless communication circuitry 1504. In some aspects, the first wireless communication circuitry 1504 may enable the display device 105 to communicate directly with the apparatus 100. In some aspects, the display device 105 and the apparatus 100 may communicate using NFC (e.g. at a frequency of 13.56 MHz). In some aspects, the first antenna 1502 of the display device 105 may include an inductor (e.g. flat antenna, loop antenna, etc.) that is configured to permit adequate field strength to be achieved when brought within adequate physical proximity to the antenna 114 of the apparatus 100.

In some aspects, the display device 105 may use the first antenna 1502 and the first wireless communication circuitry 1504 to receive sensor data from the apparatus 100. In some aspects, the computer 1514 may store the received sensor data in the memory 1516. In some aspects, the memory 1516 may be non-volatile and/or capable of being electronically erased and/or rewritten. In some aspects, the memory 1516 may be, for example and without limitations a Flash memory.

In some aspects, the received sensor data may include light measurements, temperature measurements, and time stamps. In some aspects, the computer 1514 may use the sensor data to calculate analyte levels (e.g., blood glucose levels). In some aspects, calculating analyte levels may include calculating an individual analyte level for each sensing area 2202 of the analyte sensor 100 and calculating a combined analyte level based on at least the individual analyte levels (e.g., via weighted averaging of the individual analyte levels). In some aspects, the computer 1514 may store the calculated analyte levels in the memory 1516.

In some aspects, the display device 105 may include a transceiver interface device. In some aspects, the transceiver interface device may include the second antenna 1506 and the second wireless communication circuitry 1508. In some aspects, the second wireless communication circuitry 1508 may enable wireless communication by the display device 105 with one or more external devices, such as, for example, one or more personal computers, one or more transceivers 101, and/or one or more other display devices 105 via the second antenna 1506. In some aspects, the second wireless communication circuitry 1508 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1506 may be, for example and without limitation, a Bluetooth antenna.

In some aspects, the display device 105 may use the second antenna 1506 and the second wireless communication circuitry 1508 to receive sensor data and/or calculated analyte levels from the transceiver 101. In some aspects, the computer 1514 may store the received sensor data and/or the received calculated analyte levels in the memory 1516. In some aspects, the computer 1514 may use the sensor data to calculate analyte levels. In some aspects (e.g., some aspects in which the display device 105 does not receive calculated analyte levels from transceiver 101), the computer 1514 may calculate analyte levels based on the sensor data received from the transceiver 101. In some aspects, the computer 1514 may store the calculated analyte levels in the memory 1516.

In some aspects in which the display device 105 includes the third antenna 1510 and the third wireless communication circuitry 1512, the third antenna 1510 and the third wireless communication circuitry 1512 may enable the display device 105 to communicate with one or more remote devices (e.g., smartphones, servers, and/or personal computers) via wireless local area networks (e.g., Wi-Fi), cellular networks, and/or the Internet. In some aspects, the third wireless communication circuitry 1512 may employ one or more wireless communication standards to wirelessly transmit data. In some aspects, the third antenna 1510 may be, for example and without limitation, a Wi-Fi antenna and/or one or more cellular antennas.

In some aspects in which the display device 105 includes the user interface 1518, the user interface 1518 may include a display 1522 and/or a user input 1520. In some aspects, the display 1522 may be a liquid crystal display (LCD) and/or light emitting diode (LED) display. In some aspects, the user input 1520 may include one or more buttons, a keyboard, a keypad, and/or a touchscreen. In some aspects, the computer 1514 may control the display 1522 to display data (e.g., calculated analyte levels, analyte level trend information, alerts, alarms, and/or notifications). In some aspects, the user interface 1518 may include one or more of a speaker 1524 (e.g., a beeper) and a vibration motor, which may be activated, for example, in the event that a condition (e.g., a hypoglycemic or hyperglycemic condition) is met.

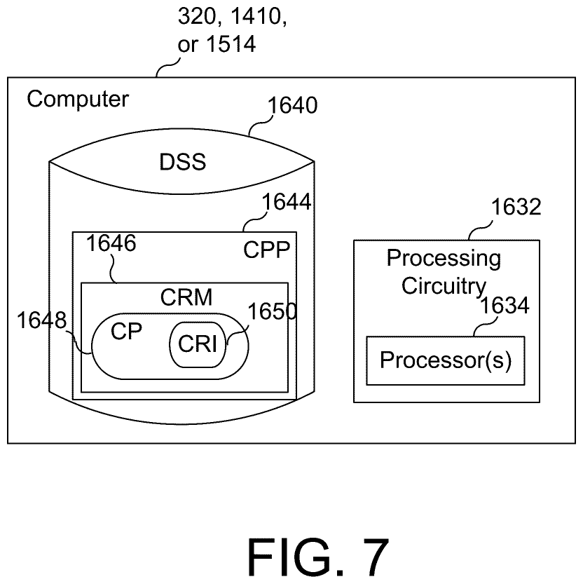

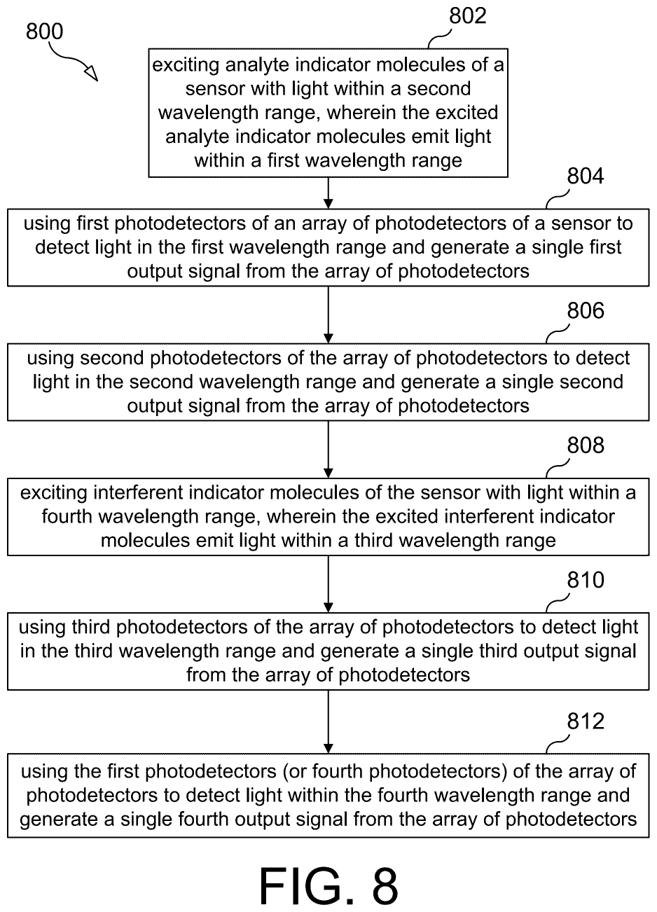

FIG. 7 is a block diagram of an aspect of a computer (e.g., the measurement controller 320 of the apparatus 100, the computer 1410 of the transceiver 101, and/or the computer 1514 of the display device 105) of the system 50. As shown in FIG. 7, in some aspects, the computer may include processing circuitry 1632 and/or one or more circuits, such as an application specific integrated circuit (ASIC), field-programmable gate arrays (FPGAs), a logic circuit, and the like. The processing circuitry 1632 may include one or more processors 1634 (e.g., one or more general purpose microprocessors). In some aspects, the computer may include a data storage system (DSS) 1640. The DSS 1640 may include one or more non-volatile storage devices and/or one or more volatile storage devices (e.g., random access memory (RAM)). In aspects where the computer includes processing circuitry 1632, the DSS 1640 may include a computer program product (CPP) 1644. CPP 1644 may include or be a computer readable medium (CRM) 1646. The CRM 1646 may store a computer program (CP) 1648 comprising computer readable instructions (CRI) 1650. In some aspects in which the computer is the computer 1514 of the display device 105, the CRM 1646 may store, among other programs, the MMA, and the CRI 1650 may include one or more instructions of the MMA. The CRM 1646 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 1650 of computer program 1648 may be configured such that when executed by processing circuitry 1632, the CRI 1650 causes the computer to perform process steps (e.g., the process 800 described below with respect to FIG. 8). In other aspects, the computer may be configured to perform steps described herein without the need for a computer program. That is, for example, the computer may consist merely of one or more ASICs. Hence, the features of the aspects described herein may be implemented in hardware and/or software.

FIG. 8 is a flowchart illustrating a process 800 according to some aspects. In some aspects, one or more steps of the process 800 may be performed by the analyte monitoring system 50 (e.g., by the analyte sensor 100 of the analyte monitoring system 50).

In some aspects, the process 800 may include a step 802 of exciting analyte indicator molecules 1306 (e.g., of analyte and/or interferent indicator material 104 associated with a sensing area 2202 of the analyte sensor 100) with excitation light within a second wavelength range. In some aspects, one or more first light sources 108 of measurement electronics 318 for a sensing area 2202 may emit the excitation light. In some aspects, the excited analyte indicator molecules 1306 may emit emission light within a first wavelength range.

In some aspects, the process 800 may include a step 804 of using first photodetectors 224 of one or more arrays of photodetectors of a sensing area 2202 of the analyte sensor 100 to generate a single first output signal from the one or more arrays of photodetectors for the sensing area 2202. In some aspects, the one or more arrays of photodetectors may be mounted on or fabricated in a substrate 112 of the analyte sensor 100. In some aspects, the first photodetectors 224 may be configured to detect light in the first wavelength range, and the first photodetectors 224 may be spatially distributed throughout each of the one or more arrays of photodetectors.

In some aspects, each photodetector of the one or more arrays of photodetectors for the sensing area 2202 may include an anode and a cathode. In some aspects, the anodes of the first photodetectors 224 of the one or more arrays of photodetectors for the sensing area 2202 may be connected together. In some aspects, the cathodes of the first photodetectors 224 of the one or more arrays of photodetectors for the sensing area 2202 may be connected together.

In some aspects, the process 800 may include a step 806 of using second photodetectors 226 of the one or more arrays of photodetectors for the sensing area 2202 to generate a single second output signal from the array of photodetectors for the sensing area 2202. In some aspects, the second photodetectors 226 may be configured to detect light in a second wavelength range that is different from the first wavelength range. In some aspects, the second photodetectors 224 may be spatially distributed throughout each of the one or more arrays of photodetectors of the sensing area 2202. In some aspects, the anodes of the second photodetectors 226 of the one or more arrays of photodetectors for the sensing area 2202 may be connected together. In some aspects, the cathodes of the second photodetectors 226 of the one or more arrays of photodetectors for the sensing area 2202 may be connected together.

In some aspects, the process 800 may include a step 808 of exciting interferent indicator molecules 1308 (e.g., of analyte and/or interferent indicator material 104 associated with the sensing area 2202 of the analyte sensor 100) with excitation light within a fourth wavelength range, which may be the same as or different than the first wavelength range. In some aspects, one or more second light sources 227 of the measurement electronics 318 for the sensing area 2202 may emit the excitation light within the fourth wavelength range. In some aspects, the excited interferent indicator molecules 1308 may emit emission light within a third wavelength range.

In some aspects, the process 800 may include a step 810 of using third photodetectors 228 of the one or more arrays of photodetectors of the sensing area 2202 to generate a single third output signal from the one or more arrays of photodetectors of the sensing area 2202. In some aspects, the third photodetectors 228 may be configured to detect light in a third wavelength range that is different from the first and second wavelength ranges. In some aspects, the third photodetectors are spatially distributed throughout each of the one or more arrays of photodetectors of the sensing area 2202. In some aspects, the anodes of the third photodetectors 228 of the one or more arrays of photodetectors of the sensing area 2202 may be connected together, and the cathodes of the third photodetectors 228 of the one or more arrays of photodetectors of the sensing area 2202 may be connected together.

In some aspects, the process 800 may include a step 812 of generate a single fourth output signal from the array of photodetectors for the sensing area 2202. In some aspects in which the fourth wavelength range is the same as the first wavelength range, the first photodetectors 224 of the one or more arrays of photodetectors of the sensing area 2202 may generate the single fourth output signal from the one or more arrays of photodetectors for the sensing area 2202. In some alternative aspects in which the fourth wavelength range is different than the first wavelength range, fourth photodetectors 230 of the one or more arrays of photodetectors of the sensing area 2202 may generate the single fourth output signal from the one or more arrays of photodetectors for the sensing area 2202, the fourth photodetectors 230 may be configured to detect light in the fourth wavelength range, and the fourth photodetectors 230 may be spatially distributed throughout each of the one or more arrays of photodetectors of the sensing area 2202. In some aspects in which fourth photodetectors 230 generate the single fourth output signal, the anodes of the fourth photodetectors 230 of the one or more arrays of photodetectors for the sensing area 2202 may be connected together, and the cathodes of the fourth photodetectors 230 of the one or more arrays of photodetectors for the sensing area 2202 may be connected together.

In some aspects, although FIG. 8 shows steps 802, 804, and 806 of the process 800 being performed sequentially, this is not required, and, in some alternative aspects, steps 802, 804, and 806 may be performed in parallel (e.g., roughly simultaneously). In some aspects, although FIG. 8 shows steps 808, 810, and 812 of the process 800 being performed sequentially, this is not required, and, in some alternative aspects, steps 808, 810, and 812 may be performed in parallel (e.g., roughly simultaneously). Although FIG. 8 shows steps 802, 804, and 806 being performed before steps 808, 810, and 812, this is not required, and, in some alternative aspects, steps 808, 810, and 812 may be performed before steps 802, 804, and 806. In some aspects in which the analyte sensor 100 includes more than one sensing area 2202, the process 800 may include performing steps 802, 804, 806, 808, 810, and 812 for each sensing area 2202 of the analyte sensor 100.

In some aspects, each of the steps 804, 806, 810, and 812 may include storing a measurement of the generated output signals (e.g., in a memory 824) of the analyte sensor 100. In some aspects, the process 800 may include a step 814 of conveying (e.g., using the antenna 114 of the analyte sensor 100) measurements of the generated output signals, which may be received by the transceiver 101 or display device 105 and used by the analyte monitoring system to calculate and display an analyte level for each sensing area 2202 (and a combined analyte level).

Aspects of the present invention have been fully described above with reference to the drawing figures. Although the invention has been described based upon these preferred aspects, it would be apparent to those of skill in the art that certain modifications, variations, and alternative constructions could be made to the described aspects within the spirit and scope of the invention. Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A sensor comprising:
a substrate; and
an array of photodetectors mounted on or fabricated in the substrate, wherein:
the array of photodetectors includes first photodetectors configured to detect light in a first wavelength range and second photodetectors configured to detect light in a second wavelength range that is different from the first wavelength range,
the first photodetectors are spatially distributed throughout the array of photodetectors,
the second photodetectors are spatially distributed throughout the array of photodetectors,
each photodetector of the array of photodetectors includes an anode and a cathode,
the anodes of the first photodetectors are connected together,
the cathodes of the first photodetectors are connected together,
the anodes of the second photodetectors are connected together,
the cathodes of the second photodetectors are connected together,
the first photodetectors generate a single first output signal from the array of photodetectors, and
the second photodetectors generate a single second output signal from the array of photodetectors.

2. The sensor of claim 1, wherein the first photodetectors are interleaved with the second photodetectors.

3. The sensor of claim 1, wherein the array of photodetectors includes rows and columns, each of the rows includes at least one of the first photodetectors and at least one of the second photodetectors, each of the columns includes at least one of the first photodetectors and at least one of the second photodetectors, none of the first photodetectors of the array of photodetectors is adjacent to another of the first photodetectors, and none of the second photodetectors of the array of photodetectors is adjacent to another of the second photodetectors.

4. The sensor of claim 3, wherein at least one of the rows and/or at least one of the columns includes two or more of the first photodetectors.

5. The sensor of claim 1, further comprising analyte indicator molecules that are excited by light within the second wavelength range and emit light within the first wavelength range.

6. The sensor of claim 1, wherein:
the array of photodetectors further includes third photodetectors configured to detect light in a third wavelength range that is different from the first and second wavelength ranges,
the third photodetectors are spatially distributed throughout of the array of photodetectors,
the anodes of the third photodetectors are connected together,
the cathodes of the third photodetectors are connected together, and
the third photodetectors generate a single third output signal from the array of photodetectors.

7. The sensor of claim 6, wherein the first photodetectors are interleaved with the second and third photodetectors.

8. The sensor of claim 6, wherein the array of photodetectors includes rows and columns, each of the rows includes at least one of the third photodetectors, each of the columns includes at least one of the third photodetectors, none of the third photodetectors of the array of photodetectors is adjacent to another of the third photodetectors.

9. The sensor of claim 6, further comprising degradation indicator molecules that emit light in the third wavelength range.

10. The sensor of claim 1, wherein:
the array of photodetectors is a first array of photodetectors,
the sensor further comprises a second array of photodetectors mounted on or fabricated in the substrate,
the second array of photodetectors includes first photodetectors configured to detect light in the first wavelength range and second photodetectors configured to detect light in the second wavelength range,
the first photodetectors of the second array of photodetectors are spatially distributed throughout the second array of photodetectors,
the second photodetectors of the second array of photodetectors are spatially distributed throughout the second array of photodetectors,
each photodetector of the second array of photodetectors includes an anode and a cathode,
the anodes of the first photodetectors of the second array of photodetectors are connected together,
the cathodes of the first photodetectors of the second array of photodetectors are connected together,
the anodes of the second photodetectors of the second array of photodetectors are connected together,
the cathodes of the second photodetectors of the second array of photodetectors are connected together,
the first photodetectors of the second array of photodetectors generate a single first output signal from the second array of photodetectors, and
the second photodetectors of the second array of photodetectors generate a single second output signal from the second array of photodetectors.

11. The sensor of claim 10, wherein the first photodetectors of the second array of photodetectors are interleaved with the second photodetectors of the second array of photodetectors.

12. The sensor of claim 10, wherein the second array of photodetectors includes rows and columns, each of the rows of the second array of photodetectors includes at least one of the first photodetectors of the second array of photodetectors and at least one of the second photodetectors of the second array of photodetectors, each of the columns of the second array includes at least one of the first photodetectors of the second array and at least one of the second photodetectors, none of the first photodetectors of the second array is adjacent to another of the first photodetectors of the second array, and none of the second photodetectors of the second array is adjacent to another of the second photodetectors of the second array.

13. The sensor of claim 12, wherein at least one of the rows of the second array and/or at least one of the columns of the second array includes two or more of the first photodetectors of the second array.

14. The sensor of claim 1, further comprising a light source mounted on or fabricated in the substrate, wherein the light source is configured to emit light in the second wavelength range.

15. The sensor of claim 14, wherein the light source is interleaved with the photodetectors of the array of photodetectors.

16. The sensor of claim 14, wherein the array of photodetectors is a first array of photodetectors, the sensor further comprises a second array of photodetectors, and the light source is between the first and second arrays.

17. The sensor of claim 1, further comprising first and second light sources mounted on or fabricated in the substrate.

18. The sensor of claim 17, wherein the first light source is configured to emit light in the second wavelength range.

19. The sensor of claim 17, wherein the second light source is configured to emit light in the first wavelength range.

20. The sensor of claim 17, wherein the first and second light sources are interleaved with the photodetectors of the array of photodetectors and with each other.

21. The sensor of claim 17, wherein the array of photodetectors is a first array of photodetectors, the sensor further comprises a second array of photodetectors, and the first and second light sources are between the first and second arrays.

22. The sensor of claim 17, wherein the first light source comprises a first light emitting active area, the second light source comprises a second light emitting active area, the first light source is adjacent to the second light source, and the first and second light sources are oriented such that the first and second light emitting active areas are co-located.

23. The sensor of claim 1, further comprising:
first optical filters configured to allow light in the first wavelength range to reach the first photodetectors and to prevent light outside the first wavelength range from reaching the first photodetectors; and
second optical filters configured to allow light in the second wavelength range to reach the second photodetectors and to prevent light outside the second wavelength range from reaching the second photodetectors.

24. A sensor comprising:
a first light source comprising a first light emitting active area;
a second light source comprising a second light emitting active area; and
a substrate, wherein the first light source is mounted on or fabricated in the substrate, the second light source is mounted on or fabricated in the substrate adjacent to the first light source, and the first and second light sources are oriented such that the first and second light emitting active areas are co-located.

25. A sensor comprising:
a substrate; and
a column of photodetectors mounted on or fabricated in the substrate, wherein:
the column of photodetectors includes first photodetectors configured to detect light in a first wavelength range and second photodetectors configured to detect light in a second wavelength range that is different from the first wavelength range,
none of the first photodetectors of the column of photodetectors is adjacent to another of the first photodetectors,
none of the second photodetectors of the column of photodetectors is adjacent to another of the second photodetectors,
each photodetector of the column of photodetectors includes an anode and a cathode,
the anodes of the first photodetectors are connected together,
the cathodes of the first photodetectors are connected together,
the anodes of the second photodetectors are connected together,
the cathodes of the second photodetectors are connected together,
the first photodetectors generate a single first output signal from the column of photodetectors, and
the second photodetectors generate a single second output signal from the column of photodetectors.

26. A method comprising:
using first photodetectors of an array of photodetectors of a sensor to generate a single first output signal from the array of photodetectors, wherein the array of photodetectors are mounted on or fabricated in a substrate of the sensor, the first photodetectors are configured to detect light in a first wavelength range, and the first photodetectors are spatially distributed throughout the array of photodetectors; and
using second photodetectors of the array of photodetectors to generate a single second output signal from the array of photodetectors, wherein the second photodetectors configured to detect light in a second wavelength range that is different from the first wavelength range, the second photodetectors are spatially distributed throughout the array of photodetectors, each photodetector of the array of photodetectors includes an anode and a cathode, the anodes of the first photodetectors are connected together, the cathodes of the first photodetectors are connected together, the anodes of the second photodetectors are connected together, and the cathodes of the second photodetectors are connected together.
